(19) United States
(12) Patent Application Publication
(10) Pub. No.: US 2024/0208111 A1
(43) Pub. Date: Jun. 27, 2024

(54) METHODS AND SYSTEMS FOR FORMING AN OBJECT IN A VOLUME OF A PHOTOHARDENABLE COMPOSITION

(71) Applicant: QUADRATIC 3D, INC., CHARLESTOWN, MA (US)

(72) Inventor: KAREN TWIETMEYER, BELMONT, MA (US)

(21) Appl. No.: 18/436,446

(22) Filed: Feb. 8, 2024

Related U.S. Application Data
(63) Continuation of application No. PCT/US2022/039766, filed on Aug. 9, 2022.
(60) Provisional application No. 63/231,182, filed on Aug. 9, 2021.

(51) Int. Cl. B29C 35/08; G03B 21/14; G03B 21/20

(52) U.S. Cl. CPC B29C 35/0805; G03B 21/142; G03B 21/2033; G03B 21/208

(57) ABSTRACT

The present invention includes methods and systems for forming an object in a volume of a photohardenable composition wherein the methods and systems preferably include telecentric illumination optics and/or telecentric projection optics.

### CROSS-REFERENCE TO RELATED APPLICATIONS

This application is a continuation of International Application No. PCT/US2022/039766, filed 9 Aug. 2022, which International Application claims priority to U.S. Provisional Patent Application No. 63/231,182 filed on 9 Aug. 2021, each of which applications is hereby incorporated herein by reference in its entirety for all purposes.

### TECHNICAL FIELD OF THE INVENTION

The present relates to the technical field of volumetric printing and related methods and systems.

### BRIEF SUMMARY OF THE INVENTION

The present invention includes methods and systems for forming an object in a volume of a photohardenable composition. Preferably the methods and systems include telecentric illumination optics and/or telecentric projection optics.

In accordance with one aspect of the present invention, there is provided a method of forming an object in a volume of a photohardenable composition, the method comprising: (a) providing a volume of the photohardenable composition included within a container wherein at least a portion of the container is optically transparent so that the photohardenable composition is accessible by excitation light; (b) projecting one or more optical projections of excitation light from one or more projection systems into the volume of the photohardenable composition to one or more selected locations in the volume, wherein at least one of the one or more optical projections is projected from a projection system including a projection device and at least one of: (i) telecentric illumination optics positioned in the optical illumination path of the excitation light for illuminating the projection device for projecting at least one of the one or more optical projections and (ii) telecentric projection optics positioned in the optical projection path between the projection device for projecting the at least one of the one or more optical projections and the volume of the photohardenable composition, wherein the photohardenable composition is at least partially hardened at the one or more selected locations in the volume; and (c) optionally repeating step (b) one or more times until the object is partially or fully formed.

In accordance with another aspect of the present invention there is provided a method of forming an object in a volume of a photohardenable composition, the method comprising: (a) providing a volume of the photohardenable composition included within a container wherein at least a portion of the container is optically transparent so that the photohardenable composition is accessible by excitation light; (b) projecting one or more optical projections of excitation light from one or more projection systems into the volume of the photohardenable composition to one or more selected locations in the volume, wherein at least one of the one or more optical projections is projected from a projection system including telecentric projection optics arranged in the optical projection path between a projection device for projecting the at least one of the one or more optical projections and the volume of the photohardenable composition, wherein the photohardenable composition is at least partially hardened at the one or more selected locations in the volume; and (c) optionally repeating step (b) one or more times until the object is partially or fully formed.

In accordance with another aspect of the present invention, there is provided a method of forming an object in a volume of a photohardenable composition, the method comprising: (a) providing a volume of the photohardenable composition included within a container wherein at least a portion of the container is optically transparent so that the photohardenable composition is accessible by excitation light; (b) projecting one or more optical projections of excitation light from one or more projection systems into the volume of the photohardenable composition to one or more selected locations in the volume, wherein at least one of the one or more optical projections is projected from a projection system including telecentric illumination optics arranged in the optical illumination path of the excitation light for illuminating a projection device for projecting the at least one of the one or more optical projections, wherein the photohardenable composition is at least partially hardened at the one or more selected locations in the volume; and (c) optionally repeating step (b) one or more times until the desired object is partially or fully formed.

In accordance with yet another aspect of the present invention, there is provided method of forming an object in a volume of a photohardenable composition, the method comprising: (a) providing a volume of the photohardenable composition included within a container wherein at least a portion of the container is optically transparent so that the photohardenable composition is accessible by excitation light; (b) projecting one or more optical projections of excitation light from one or more projection systems into the volume of the photohardenable composition to one or more selected locations in the volume, wherein at least one of the one or more optical projections is projected from a projection system including telecentric illumination optics arranged in the optical illumination path of the excitation light for illuminating a projection device for projecting the at least one of the one or more optical projections and telecentric projection optics arranged in the optical projection path between the projection device for projecting the at least one of the one or more optical projections and the volume of the photohardenable composition, wherein the photohardenable composition is at least partially hardened at the one or more selected locations in the volume; and (c) optionally repeating step (b) one or more times until the object is partially or fully formed.

In accordance with another aspect of the present invention, there is provided a method of forming an object in a volume of a photohardenable composition, the method comprising: (a) providing a volume of the photohardenable composition included within a container wherein at least a portion of the container is optically transparent so that the photohardenable composition is accessible by excitation light; (b) projecting at least two optical projections of excitation light from one or more projection systems into the volume of the photohardenable composition to one or more selected locations in the volume, the at least two optical projections comprising a first optical projection including first excitation light including light having a first wavelength and a second optical projection including a second excitation light including light having a second wavelength, wherein the second optical projection is projected from a projection system including a projection device and at least one of: (i) telecentric illumination optics positioned in the optical illumination path of the excitation light for illuminating the projection device for projecting at least one of the one or more optical projections and (ii) telecentric projection optics positioned in the optical projection path between the projection device for projecting the at least one of the one or more optical projections and the volume of the photohardenable composition, wherein the photohardenable composition is at least partially hardened at the one or more selected locations in the volume; and (c) optionally repeating step (b) one or more times until the object is partially or fully formed.

In accordance with a further aspect of the present invention, there is provided a method of forming an object in a volume of a photohardenable composition, the method comprising: (a) providing a volume of the photohardenable composition included within a container wherein at least a portion of the container is optically transparent so that the photohardenable composition is accessible by excitation light; (b) projecting at least two optical projections of excitation light from one or more projection systems into the volume of the photohardenable composition to one or more selected locations in the volume, the at least two optical projections comprising a first optical projection including first excitation light including light having a first wavelength and a second optical projection including a second excitation light including light having a second wavelength, wherein the second optical projection is projected from a projection system including telecentric projection optics arranged in the optical projection path between a projection device for projecting the second optical projection and the volume of the photohardenable composition, wherein the photohardenable composition is at least partially hardened at the one or more selected locations in the volume; and (c) optionally repeating step (b) one or more times until the object is partially or fully formed.

In accordance with a still further aspect of the present invention, there is provided a method of forming an object in a volume of a photohardenable composition, the method comprising: (a) providing a volume of the photohardenable composition included within a container wherein at least a portion of the container is optically transparent so that the photohardenable composition is accessible by excitation light; (b) projecting at least two optical projections of excitation light from one or more projection systems into the volume of the photohardenable composition to one or more selected locations in the volume, the at least two optical projections comprising a first optical projection including first excitation light including light having a first wavelength and a second optical projection including a second excitation light having a second wavelength, wherein the second optical projection is projected from a projection system including telecentric illumination optics arranged in the optical illumination path of the second excitation light for illuminating a projection device for projecting the second optical projection, wherein the photohardenable composition is at least partially hardened at the one or more selected locations in the volume; and (c) optionally repeating step (b) one or more times until the object is partially or fully formed.

In accordance with a still further aspect of the present invention, there is provided a method of forming an object in a volume of a photohardenable composition, the method comprising: (a) providing a volume of the photohardenable composition included within a container wherein at least a portion of the container is optically transparent so that the photohardenable composition is accessible by excitation light; (b) projecting at least two optical projections of excitation light from one or more projection systems into the volume of the photohardenable composition to one or more selected locations in the volume, the at least two optical projections comprising a first optical projection including first excitation light having a first wavelength and a second optical projection including a second excitation light having a second wavelength, wherein the second optical projection is projected from a projection system including telecentric illumination optics arranged in the optical illumination path of the second excitation light for illuminating a projection device for projecting the second optical projection and telecentric projection optics arranged in the optical projection path between the projection device for projecting the second optical projection and the volume of the photohardenable composition, wherein the photohardenable composition is at least partially hardened at the one or more selected locations in the volume; and (c) optionally repeating step (b) one or more times until the object is partially or fully formed.

The methods described herein can further include separating the partially or fully formed objects from the photohardenable composition after formation.

The methods described herein can further include post-processing. Examples of post-processing steps that may be further included in a method in accordance with the invention include, but are not limited to, one or more of the following: washing, post-curing, metrology, drying, and packaging.

In accordance with a still further aspect of the present invention, there is provided a system for forming an object in a volume of a photohardenable composition, the system comprising: one or more projection systems configured for receiving excitation light and projecting one or more optical projections into the volume of the photohardenable composition, wherein at least one of the projection systems includes a projection device and one or more telecentric optics arrangements positioned in: (a) the optical illumination path of the excitation light for illuminating the projection device for projecting at least one of the one or more optical projections and/or (b) the optical projection path between the projection device for projecting the at least one of the one or more optical projections and the volume of the photohardenable composition.

The system is preferably further configured to include a container for including the volume of the photohardenable composition. The container preferably includes at least one or more portions that are optically transparent so that the photohardenable composition is accessible by excitation light. A container can optionally be included as a component of the system or can be separately supplied. In either case, it can be desirable for the container to be removable from the system. It can further be desirable for the container to be reusable.

The system can further include one or more lighting sources which are arranged to provide excitation light to the one or more projection systems.

In accordance with a still further aspect of the present invention, there is provided a system for forming an object in a volume of a photohardenable composition, the system comprising: a container adapted to include the volume of the photohardenable composition wherein at least a portion of the container is optically transparent so that the photohardenable composition is accessible by excitation light; and one or more projection systems configured for receiving excitation light and projecting one or more optical projections into the volume included in the container, wherein at least one of the projection systems includes a projection device and one or more telecentric optics arrangements positioned in: (a) the optical illumination path of the excitation light for illuminating the projection device for projecting at least one of the one or more optical projections and/or (b) the optical projection path between the projection device for projecting the at least one of the one or more optical projections and the container.

In accordance with a still further aspect of the present invention, there is provided a system for forming an object in a volume of a photohardenable composition, the system comprising: a container adapted to include the volume of the photohardenable composition wherein at least a portion of the container is optically transparent so that the photohardenable composition is accessible by excitation light; one or more lighting sources which are arranged to provide excitation light to one or more projection systems configured for receiving excitation light and projecting one or more optical projections into the volume included in the container, wherein at least one projection system includes a projection device and one or more telecentric optics arrangements positioned in: (a) the optical illumination path between a light source and the projection device for projecting at least one of the one or more optical projections and/or (b) the optical projection path between the projection device for projecting the at least one of the one or more optical projections and the container.

In accordance with a still further aspect of the present invention, there is provided a system for forming an object in a volume of a photohardenable composition, the system comprising: one or more projection systems configured for receiving excitation light and projecting two or more optical projections into the volume of the photohardenable composition, the two or more optical projections including a first optical projection including a first excitation light having a first wavelength and a second optical projection including a second excitation light having a second wavelength, wherein at least one of the projection systems includes a projection device and one or more telecentric optics arrangements positioned in: (a) the optical illumination path of the second excitation light for illuminating the projection device for projecting the second optical projection and/or (b) the optical projection path between the projection device for projecting the second optical projection and the volume of the photohardenable composition.

The system is preferably further configured to include a container for including the volume of the photohardenable composition. The container preferably includes at least one or more portions that are optically transparent so that the photohardenable composition is accessible by excitation light. A container can optionally be included as a component of the system or can be separately supplied. In either case, it can be desirable for the container to be removable from the system. It can further be desirable for the container to be reusable.

The system can further include two or more lighting sources which are arranged to provide first excitation light including light having a first wavelength and second excitation light including light having a second wavelength to one or more projection systems.

In accordance with a still further aspect of the present invention, there is provided a system for forming an object in a volume of a photohardenable composition, the system comprising: a container adapted to include the volume of the photohardenable composition wherein at least a portion of the container is optically transparent so that the photohardenable composition is accessible by excitation light; one or more projection systems configured for receiving excitation light and projecting two or more optical projections into the volume included in the container, the two or more optical projections including a first optical projection including a first excitation light having a first wavelength and a second optical projection including a second excitation light having a second wavelength, wherein at least one of the projection systems includes a projection device and one or more telecentric optics arrangements positioned in: (a) the optical illumination path of the second excitation light for illuminating the projection device for projecting the second optical projection and/or (b) the optical projection path between the projection device for projecting the second optical projection and the container.

In accordance with a still further aspect of the present invention, there is provided a system for forming an object in a volume of a photohardenable composition, the system comprising: a container adapted to include the volume of the photohardenable composition wherein at least a portion of the container is optically transparent so that the photohardenable composition is accessible by excitation light; two or more lighting sources which are arranged to provide first excitation light including light having a first wavelength and second excitation light including light having a second wavelength to one or more projection systems; and one or more projection systems configured for receiving the first excitation light and the second excitation light and projecting two or more optical projections into the volume included in the container, the two or more optical projections including a first optical projection including the first excitation light and a second optical projection including the second excitation light, wherein at least one of the projection systems includes a projection device and one or more telecentric optics arrangements positioned in: (a) the optical illumination path between a light source for generating second excitation light and the projection device for projecting the second optical projection and/or (b) the optical projection path between the projection device for projecting the second optical projection and the container.

In accordance with another aspect of the present invention, there is provided a system for forming an object in a volume of a photohardenable composition, the system comprising: one or more projection systems configured for receiving excitation light and projecting one or more optical projections into the volume included in the container, wherein at least one of the projection systems includes an optical arrangement for generating a light sheet, the optical arrangement including a collimated light source, one or more optical elements for receiving collimated light from the light source and generating a fan of light rays, a first cylinder lens for receiving the fan of light rays, and a second cylinder lens for receiving the light passing through the first cylinder lens, wherein the first cylinder lens includes an axis with nonzero curvature in the direction of the fan of light rays for collimating the fan of light rays into a substantially constant height plane of light and the second cylinder lens includes an axis with nonzero curvature orthogonal to the axis of the first cylinder lens to focus the orthogonal collimated direction of light output from the collimated light source into the into the volume for control of plane width.

The system is preferably further configured to include a container for including the volume of the photohardenable composition. The container preferably includes at least one or more portions that are optically transparent so that the photohardenable composition is accessible by excitation light. A container can optionally be included as a component of the system or can be separately supplied. In either case, it can be desirable for the container to be removable from the system. It can further be desirable for the container to be reusable.

In accordance with another aspect of the present invention, there is provided a system for forming an object in a volume of a photohardenable composition, the system comprising two or more projection systems configured for receiving excitation light and projecting one or more optical projections to intersect at one or more selected location in the volume of the photohardenable composition to at least partially harden, polymerize, or crosslink the photohardenable composition to at least partially form one or more objects, wherein the one or more projection systems include a first projection system including an optical arrangement for generating a first optical projection comprising a light sheet, the optical arrangement including one or more optical elements for receiving excitation light and projecting the light sheet to the one or more selected locations in the volume, the optical elements including an element to generate the light sheet from excitation light and a first cylinder lens and a second cylinder lens configured for adjusting the dimensions of the light sheet, wherein the first cylinder lens includes an axis with nonzero curvature in the direction of the fan of light rays and the second cylinder lens includes an axis with nonzero curvature orthogonal to the axis of the first cylinder lens; and a second projection system including an illumination section, a projection device, and a projection section for projecting a second optical projection to a selected location in the volume, wherein at least one of the illumination section and projection system include telecentric optics.

The system is preferably further configured to include a container for including the volume of the photohardenable composition. The container preferably includes at least one or more portions that are optically transparent so that the photohardenable composition is accessible by excitation light. A container can optionally be included as a component of the system or can be separately supplied. In either case, it can be desirable for the container to be removable from the system. It can further be desirable for the container to be reusable.

The system can further include a light source arranged to provide excitation light to the optical arrangement.

In the systems and methods in accordance with the present invention, the selection of wavelength(s) of the excitation light for the excitation light projections is preferably made taking into account the photohardenable composition and hardening mechanism being used.

For example, for photohardenable compositions that are hardenable via a hardening mechanism that involves a single wavelength of excitation light, the wavelength of the excitation light projection(s) can be the same. Optionally in such case, an excitation light projection including a different wavelength light can also be included, for example for inhibiting undesired hardening of the photohardenable composition.

In cases where a photohardenable composition is hardenable via a hardening mechanism that involves more than one wavelength of excitation light, the wavelengths of the excitation light projections will be selected for projecting excitation light with appropriate wavelengths for the hardening mechanism. Optionally an additional wavelength light can also be used to inhibit undesired hardening of the photohardenable composition.

Systems and methods in accordance with the present invention can further include one or more control systems for controlling at least one of the selective projections of the at least two excitation light projections to one or more selected locations.

The methods and systems described herein are typically used in combination with a computer and software. Software can be used to coordinate generation of optical projections (e.g., point illuminations, line illuminations, a two-dimensional pattern, or a light sheet) from their respective optical projection system at each position along the projection direction of each so that the part is developed plane by plane. The planar face of an optical projection can be orthogonal to its projection direction into photohardenable composition. When two optical projections are projected into the volume, the projection directions of the two projections are preferably orthogonal to each other. Selection of computer controls and software is within the skill of the person of ordinary skill in the relevant art. Other components can also optionally be included or used with the system.

An optical projection system is also referred to herein as a projection system.

Systems and methods in accordance with the present invention advantageously further do not require adhering the object being printed to a fixed substrate (e.g., build plate) at the beginning of the printing process avoiding a post-processing step of separating the printed object from the fixed substrate.

In systems and methods in accordance with aspects of the invention including more than one excitation light projection, optionally one or more of the excitation light projections can comprise a light sheet, which may be constructed by means known in the art that can include, for example, but not limited to: a cylindrical lens, Powell lens, galvanometer, polygon scanning mirror (also referred to herein as a polygon scanner), MEMS scanner, diffractive optical element, axicon lens.

In systems and methods in accordance aspects of the invention including more than one excitation light projection, it can be preferred for at least two of the at least two excitation light projections to be perpendicular to each other

Methods and systems described herein are particularly useful for forming or “printing” three-dimensional objects.

A projection system can include a projection device and can optionally further include one or more optical components and/or mechanisms for translating the position of any of the components of the projection system. The foregoing, and other aspects and embodiments described herein and contemplated by this disclosure all constitute embodiments of the present invention.

It should be appreciated by those persons having ordinary skill in the art(s) to which the present invention relates that any of the features described herein in respect of any particular aspect and/or embodiment of the present invention can be combined with one or more of any of the other features of any other aspects and/or embodiments of the present invention described herein, with modifications as appropriate to ensure compatibility of the combinations. Such combinations are considered to be part of the present invention contemplated by this disclosure.

It is to be understood that both the foregoing general description and the following detailed description are exemplary and explanatory only and are not restrictive of the invention as claimed.

Other embodiments will be apparent to those skilled in the art from consideration of the description, from the claims, and from practice of the invention disclosed herein.

### BRIEF DESCRIPTION OF THE DRAWINGS

In the drawings,

FIG. 1 depicts a diagram of an example of a system in accordance with the present invention.

FIG. 2 depicts a diagram of an example of a system in accordance with the present invention.

FIG. 3 depicts a diagram of an example of a system in accordance with the present invention.

FIG. 4 depicts a diagram of the example of the projection system depicted in FIG. 3 with additional light ray paths drawn for more detailed illustration of optical performance.

FIG. 5 depicts a diagram of an example of a preferred system in accordance with the present invention.

FIGS. 6A and 6B depict different views of a diagram of an example of the first optical projection system depicted in FIG. 5.

The attached figures are simplified representations presented for purposes of illustration only; the actual structures may differ in numerous respects, particularly including the relative scale of the articles depicted and aspects thereof.

For a better understanding to the present invention, together with other advantages and capabilities thereof, reference is made to the following disclosure and appended claims in connection with the above-described drawings.

### DETAILED DESCRIPTION OF THE INVENTION

Various aspects and embodiments of the present inventions will be further described in the following detailed description.

The present invention includes methods and systems for forming an object in a volume of a photohardenable composition. Preferably the methods and systems include telecentric illumination optics and/or telecentric projection optics. Inclusion of telecentric optics can facilitate flexibility in selecting the size of the printing field in the volume and the feature resolution of the printed objects. Inclusion of telecentric optics can also facilitate improvements in the quality of the printed objects, in particular improved feature resolution and feature accuracy over the full volume of the printed object. Inclusion of telecentric optics can also facilitate flexibility in selecting the illumination source.

In accordance with one aspect of the present invention, there is provided a method of forming an object in a volume of a photohardenable composition, the method comprising: (a) providing a volume of the photohardenable composition included within a container wherein at least a portion of the container is optically transparent so that the photohardenable composition is accessible by excitation light; (b) projecting one or more optical projections of excitation light from one or more projection systems into the volume of the photohardenable composition to one or more selected locations in the volume, wherein at least one of the one or more optical projections is projected from a projection system including a projection device and at least one of: (i) telecentric illumination optics positioned in the optical illumination path of the excitation light for illuminating the projection device for projecting at least one of the one or more optical projections and (ii) telecentric projection optics positioned in the optical projection path between the projection device for projecting the at least one of the one or more optical projections and the volume of the photohardenable composition, wherein the photohardenable composition is at least partially hardened (e.g., via at least partial polymerization or at least partial crosslinking) at the one or more selected locations in the volume; and (c) optionally repeating step (b) one or more times until the object is partially or fully formed.

Preferably the one or more optical projections of excitation light are directed to one or more locations within the photohardenable composition selected for forming the object.

In accordance with one aspect of the present invention there is provided a method of forming an object in a volume of a photohardenable composition, the method comprising: (a) providing a volume of the photohardenable composition included within a container wherein at least a portion of the container is optically transparent so that the photohardenable composition is accessible by excitation light; (b) projecting one or more optical projections of excitation light from one or more projection systems into the volume of the photohardenable composition to one or more selected locations in the volume, wherein at least one of the one or more optical projections is projected from a projection system including telecentric projection optics arranged in the optical projection path between a projection device for projecting the at least one of the one or more optical projections and the volume of the photohardenable composition, wherein the photohardenable composition is at least partially hardened (e.g., via at least partial polymerization or at least partial crosslinking) at the one or more selected locations in the volume; and (c) optionally repeating step (b) one or more times until the object is partially or fully formed.

Preferably the one or more optical projections of excitation light are directed to one or more locations within the photohardenable composition selected for forming the object.

The telecentric projection optics can comprise an arrangement of one or more spherical and/or aspherical lenses and/or one or more spherical and/or aspherical mirrors for providing the desired telecentricity. Such arrangements can be constructed by the skilled artisan using commercially available optical components. Optionally, customized optical components (e.g., custom aspheric lenses) can also be included.

The telecentric projection optics can include object-side telecentricity, image-side telecentricity, or bi-telecentricity (object-side telecentricity and image-side telecentricity). Inclusion of bi-telecentricity can be preferred.

Multiple projections systems may be provided to address the volume of the photohardenable composition, e.g., at one or more selected locations, simultaneously or sequentially, using the same or different excitation lights. For example, two or more projection systems may be positioned on opposite or adjacent sides of the container, or at any other location relative to each other. For example, when more than one projection system is used to address the same one or more locations in the volume of the photohardenable composition, the optical projections of excitation light from each of the projection systems may be fully intersecting, partially intersecting, or nonintersecting. When more than one optical projection is projected into the container, it may be desirable for at least one of the optical projections to be orthogonal to the direction in which another optical projection is directed.

In accordance with another aspect of the present invention, there is provided a method of forming an object in a volume of a photohardenable composition, the method comprising: (a) providing a volume of the photohardenable composition included within a container wherein at least a portion of the container is optically transparent so that the photohardenable composition is accessible by excitation light; (b) projecting one or more optical projections of excitation light from one or more projection systems into the volume of the photohardenable composition to one or more selected locations in the volume, wherein at least one of the one or more optical projections is projected from a projection system including telecentric illumination optics arranged in the optical illumination path of the excitation light for illuminating a projection device for projecting the at least one of the one or more optical projections, wherein the photohardenable composition is at least partially hardened (e.g., via at least partial polymerization or at least partial crosslinking) at the one or more selected locations in the volume; and (c) optionally repeating step (b) one or more times until the desired object is partially or fully formed.

Preferably, wherein the one or more optical projections of excitation light are preferably directed to one or more locations within the photohardenable composition selected for forming the object.

The telecentric illumination optics can comprise an arrangement of one or more spherical and/or aspherical lenses and/or one or more spherical and/or aspherical mirrors for providing the desired telecentricity. Such arrangements can be constructed by the skilled artisan using commercially available optical components. Optionally, customized optical components (e.g., custom aspheric lenses) can also be included.

The telecentric illumination optics can include object-side telecentricity, image-side telecentricity, or bi-telecentricity (object-side telecentricity and image-side telecentricity). Inclusion of bi-telecentricity can be preferred.

Multiple projections systems may be provided to address the volume of the photohardenable composition, e.g., at one or more selected locations, simultaneously or sequentially, using the same or different excitation lights. For example, two or more projection systems may be positioned on opposite or adjacent sides of the container, or at any other location relative to each other. For example, when more than one projection system is used to address the same one or more locations in the volume of the photohardenable composition, the optical projections of excitation light from each of the projection systems may be fully intersecting, partially intersecting, or nonintersecting. When more than one optical projection is projected into the container, it may be desirable for at least one of the optical projections to be orthogonal to the direction in which another optical projection is directed.

In accordance with yet another aspect of the present invention, there is provided method of forming an object in a volume of a photohardenable composition, the method comprising: (a) providing a volume of the photohardenable composition included within a container wherein at least a portion of the container is optically transparent so that the photohardenable composition is accessible by excitation light; (b) projecting one or more optical projections of excitation light from one or more projection systems into the volume of the photohardenable composition to one or more selected locations in the volume, wherein at least one of the one or more optical projections is projected from a projection system including telecentric illumination optics arranged in the optical illumination path of the excitation light for illuminating a projection device for projecting the at least one of the one or more optical projection and telecentric projection optics arranged in the optical projection path between the projection device for projecting the at least one of the one or more optical projections and the volume of the photohardenable composition, wherein the photohardenable composition is at least partially hardened (e.g., via at least partial polymerization or at least partial crosslinking) at the one or more selected locations in the volume; and (c) optionally repeating step (b) one or more times until the object is partially or fully formed.

Preferably the one or more optical projections of excitation light are directed to one or more locations within the photohardenable composition selected for forming the object.

The telecentric illumination optics can comprise an arrangement of one or more spherical and/or aspherical lenses and/or one or more spherical and/or aspherical mirrors for providing the desired telecentricity. Such arrangements can be constructed by the skilled artisan using commercially available optical components. Optionally, customized optical components (e.g., custom aspheric lenses) can also be included.

The telecentric illumination optics can include object-side telecentricity, image-side telecentricity, or bi-telecentricity (object-side telecentricity and image-side telecentricity). Inclusion of bi-telecentricity can be preferred.

The telecentric projection optics can comprise an arrangement of one or more spherical and/or aspherical lenses and/or one or more spherical and/or aspherical mirrors for providing the desired telecentricity. Such arrangements can be constructed by the skilled artisan using commercially available optical components. Optionally, customized optical components (e.g., custom aspheric lenses) can also be included.

The telecentric projection optics can include object-side telecentricity, image-side telecentricity, or bi-telecentricity (object-side telecentricity and image-side telecentricity). Inclusion of bi-telecentricity can be preferred.

Methods including both telecentric illumination optics and telecentric projection optics can be preferred.

Multiple projections systems may be provided to address the volume of the photohardenable composition, e.g., at one or more selected locations, simultaneously or sequentially, using the same or different excitation lights. For example, two or more projection systems may be positioned on opposite or adjacent sides of the container, or at any other location relative to each other. For example, when more than one projection system is used to address the same one or more locations in the volume of the photohardenable composition, the optical projections of excitation light from each of the projection systems may be fully intersecting, partially intersecting, or nonintersecting. When more than one optical projection is projected into the container, it may be desirable for at least one of the optical projections to be orthogonal to the direction in which another optical projection is directed.

Methods in accordance with the present invention that include both telecentric illumination optics arranged in the optical illumination path of the excitation light for illuminating the projection device for projecting at least one of one or more optical projections and telecentric projection optics arranged in the optical projection path between the projection device for projecting the at least one of the one or more optical projections and the volume of the photohardenable composition can facilitate the ability to provide for a variable focus lens with adjustable magnification to be included in a telecentric projection lens system in the optical path between the projection device for projecting the optical projection and the container such that size of the printing field in the volume and the feature resolution of the printed objects can be modified by simple adjustment to the zoom position of the variable focus lens; the condition of telecentricity can permit the use of a fixed optical stop location within the optical design of a variable focus or zoom lens which enables the ability to design and implement such a variable magnification (zoom) lens.

Methods in accordance with the present invention that include both telecentric illumination optics arranged in the optical illumination path of the excitation light for illuminating the projection device for projecting at least one of one or more optical projections and telecentric projection optics arranged in the optical projection path between the projection device for projecting the at least one of the one or more optical projections and the volume of the photohardenable composition can facilitate the ability to exchange or swap out one or more fixed or variable focus telecentric projection lenses included in a projection lens system in the optical path between the projection device for projecting the optical projection and the container with lenses of different fixed or variable (e.g., zoom) magnifications such that size of the printing field in the volume and the feature resolution of the printed objects can be modified; the condition of telecentricity in which the optical pupils of the illumination and projection systems are located at infinity provides for straightforward pupil matching in the optical design can enable the ability to design and implement such easily swappable lenses.

Methods in accordance with the present invention that include both telecentric illumination optics arranged in the optical illumination path of the excitation light for illuminating the projection device for projecting at least one of one or more optical projections and telecentric projection optics arranged in the optical projection path between the projection device for projecting the at least one of the one or more optical projections and the volume of the photohardenable composition can facilitate the ability to exchange or swap out one or more illumination sources illuminating the projection device such that the wavelength, power, or NA of the light source can be easily modified to improve print quality; the condition of telecentricity in which the optical pupils of the illumination and projection systems are located at infinity provides for straightforward pupil matching in the optical design which can enable the ability to design and implement such easily swappable illumination sources.

Methods in accordance with the present invention that include both telecentric illumination optics arranged in the optical illumination path of the excitation light for illuminating the projection device for projecting at least one of one or more optical projections and telecentric projection optics arranged in the optical projection path between the projection device for projecting the at least one of the one or more optical projections and the volume of the photohardenable composition can facilitate the use of high numerical aperture illumination and projection; for example, if a digital micromirror device (also referred to herein as “DMD”) is used as the projection device, a numerical aperture in the upper range of DMD capability (0.1-0.2) is possible, enabling higher feature resolution of printed objects; the condition of telecentricity in which the cone of angles incident on the DMD from the illumination optics and reflected from the DMD to the projection optics is uniform across the full area of the DMD and does not require a bias or offset angle that would necessitate a reduced numerical aperture enables high numerical aperture.

Methods in accordance with the present invention that include telecentric projection optics arranged in the optical projection path between the projection device for projecting the at least one of the one or more optical projections and the volume of the photohardenable composition (whether or not telecentric illumination optics are also included) can facilitate producing an image with substantially constant magnification over a range of axial depths within the photohardenable composition such that the size of the projected image generated by the optical projection system and the lateral resolution of the projected image generated thereby are maintained over the full width of the first optical projection of excitation light and thus there are reduced and preferably no, or substantially no, distortions introduced to the printed part due to variations in magnification and/or lateral resolution; the condition of telecentricity in which the chief rays of the projection are all parallel can enable the constant magnification condition over the full width of the projection.

Methods in accordance with the present invention that include telecentric illumination optics arranged in the optical illumination path of the excitation light for illuminating the projection device for projecting at least one of one or more optical projections (whether or not telecentric projection optics are also included) can facilitate generation by the optical projection system of an image with high uniformity of irradiance over the full optical projection, for example, if a DMD is used as the projection device, greater than 98% uniformity can be achieved, thus enabling higher part accuracy over the full optical projection; the condition of telecentricity in which the cone of angles incident on the DMD from the illumination optics and reflected from the DMD to the projection optics is uniform across the full area of the DMD and can facilitate that the light field interaction with the DMD (which includes interaction with the micromirrors as well as the structure beneath the micromirrors) is uniform across the full area of the DMD, and can enable the condition of high irradiance uniformity over the full projection image.

Methods in accordance with the present invention that include telecentric illumination optics arranged in the optical illumination path of the excitation light for illuminating the projection device for projecting at least one of one or more optical projections (whether or not telecentric projection optics are also included) can facilitate generation by the optical projection system of an image with high uniformity of lateral resolution over the full optical projection, for example, if a DMD is used as the projection device, greater than 98% uniformity can be achieved, which can enable higher part accuracy over the full optical projection; the condition of telecentricity in which the cone of angles incident on the DMD from the illumination optics and reflected from the DMD to the projection optics is uniform across the full area of the DMD can minimize variation in the aberrations from the optical system across the full field and can enable the condition of high lateral resolution uniformity over the full projection image.

Methods in accordance with the present invention that include telecentric projection optics arranged in the optical projection path between the projection device for projecting the at least one of the one or more optical projections and the volume of the photohardenable composition (whether or not telecentric illumination optics are also included) can facilitate generation by the optical projection system of an image with low distortion, for example less than 0.1% distortion, thus enabling higher part accuracy over the full optical projection of the image; the condition of telecentricity in which the chief rays of the projection are all parallel enables the condition of low distortion over the full projection image.

Methods in accordance with the present invention that include telecentric projection optics arranged in the optical projection path between the projection device for projecting the at least one of the one or more optical projections and the volume of the photohardenable composition (whether or not telecentric illumination optics are also included) can enable a more compact optical design. For example, if a DMD is used as the projection device, the condition of telecentricity in which the cone of angles incident on the DMD from the illumination optics and reflected from the DMD to the projection optics, first, does not require a bias or offset angle that would increase the required size of the projection optics, and second, can allow for the use of a total internal reflection prism which reduces the projection optics back focal distance; both conditions enabling a compact optical design.

Methods in accordance with the present invention that include a first telecentric optics arrangement positioned in the optical illumination path of the excitation light for illuminating the projection device for projecting at least one of the one or more optical projections and a second telecentric optics arrangement positioned in the optical projection path between the projection device for projecting the optical projection and the container can facilitate the advantages of both telecentric illumination optics and telecentric projection optics.

In accordance with another aspect of the present invention, there is provided a method of forming an object in a volume of a photohardenable composition, the method comprising: (a) providing a volume of the photohardenable composition included within a container wherein at least a portion of the container is optically transparent so that the photohardenable composition is accessible by excitation light; (b) projecting at least two optical projections of excitation light from one or more projection systems into the volume of the photohardenable composition to one or more selected locations in the volume, the at least two optical projections comprising a first optical projection including first excitation light including light having a first wavelength and a second optical projection including a second excitation light including light having a second wavelength, wherein the second optical projection is projected from a projection system including a projection device and at least one of: (i) telecentric illumination optics positioned in the optical illumination path of the excitation light for illuminating the projection device for projecting at least one of the one or more optical projections and (ii) telecentric projection optics in the optical projection path between the projection device for projecting the at least one of the one or more optical projections and the volume of the photohardenable composition, wherein the photohardenable composition is at least partially hardened (e.g., via at least partial polymerization or at least partial crosslinking) at the one or more selected locations in the volume; and (c) optionally repeating step (b) one or more times until the object is partially or fully formed.

Preferably the one or more optical projections of excitation light are directed to one or more locations within the photohardenable composition selected for forming the object.

In accordance with a further aspect of the present invention, there is provided a method of forming an object in a volume of a photohardenable composition, the method comprising: (a) providing a volume of the photohardenable composition included within a container wherein at least a portion of the container is optically transparent so that the photohardenable composition is accessible by excitation light; (b) projecting at least two optical projections of excitation light from one or more projection systems into the volume of the photohardenable composition to one or more selected locations in the volume, the at least two optical projections comprising a first optical projection including first excitation light including light having a first wavelength and a second optical projection including a second excitation light including light having a second wavelength, wherein the second optical projection is projected from a projection system including telecentric projection optics arranged in the optical projection path between a projection device for projecting the second optical projection and the volume of the photohardenable composition, wherein the photohardenable composition is at least partially hardened (e.g., via at least partial polymerization or at least partial crosslinking) at the one or more selected locations in the volume; and (c) optionally repeating step (b) one or more times until the object is partially or fully formed.

Preferably the first and second optical projections of excitation light are directed to one or more locations within the photohardenable composition selected for forming the object.

The telecentric projection optics can comprise an arrangement of one or more spherical and/or aspherical lenses and/or one or more spherical and/or aspherical mirrors for providing the desired telecentricity. Such arrangements can be constructed by the skilled artisan using commercially available optical components. Optionally, customized optical components (e.g., custom aspheric lenses) can also be included.

The telecentric projection optics can include object-side telecentricity, image-side telecentricity, or bi-telecentricity (object-side telecentricity and image-side telecentricity). Inclusion of bi-telecentricity can be preferred.

Multiple projections systems may be provided to address the photohardenable composition, e.g., at one or more selected locations, simultaneously or sequentially, using the same or different excitation lights. For example, two or more projection systems may be positioned on opposite or adjacent sides of the container, or at any other location relative to each other. For example, when two or more projection systems are used to address the same one or more locations in the volume of the photohardenable composition, the optical projections of excitation light from each of the projection systems may be fully intersecting, partially intersecting, or nonintersecting. It may be desirable for two or more of the optical excitation projections from two or more projection systems to be projected such that at least one of the optical projections (e.g., the second orthogonal projection) is orthogonal to the direction in which the first optical projection is directed.

In methods in accordance with the present invention that include two or more excitation light projections, optionally one of the two or more optical projections can comprise a plane of light including a major face (which may also be referred to herein as a light sheet). Light sheets can be constructed by means known in the art including, for example, but not limited to, a laser with one or more optical components. For example, a first optical projection comprising a plane of light including a major face, can be generated with a light source and arrangement elements including a Powell lens and one, two, or more optical components (e.g., a combination of lenses and/or mirrors). Other examples of light sheet generation methods include galvanometers, polygon scanners, MEMS scanners, diffractive optical elements, cylindrical lenses, and axicon lenses, with or without additional optical components. Light sources may include lasers, LEDs, and/or thermal (lamp) sources. Optionally one or more of the orthogonal excitation light projections can comprise a light sheet. A light source comprising a laser can be preferred.

In accordance with a still further aspect of the present invention, there is provided a method of forming an object in a volume of a photohardenable composition, the method comprising: (a) providing a volume of the photohardenable composition included within a container wherein at least a portion of the container is optically transparent so that the photohardenable composition is accessible by excitation light; (b) projecting at least two optical projections of excitation light from one or more projection systems into the volume of the photohardenable composition to one or more selected locations in the volume, the at least two optical projections comprising a first optical projection including first excitation light including light having a first wavelength and a second optical projection including a second excitation light having a second wavelength, wherein the second optical projection is projected from a projection system including telecentric illumination optics arranged in the optical illumination path of the second excitation light for illuminating a projection device for projecting the second optical projection, wherein the photohardenable composition is at least partially hardened (e.g., via at least partial polymerization or at least partial crosslinking) at the one or more selected locations in the volume; and (c) optionally repeating step (b) one or more times until the object is partially or fully formed.

Preferably the first and second optical projections of excitation light are directed to one or more locations within the photohardenable composition selected for forming the object.

The telecentric illumination optics can comprise an arrangement of one or more spherical and/or aspherical lenses and/or one or more spherical and/or aspherical mirrors for providing the desired telecentricity. Such arrangements can be constructed by the skilled artisan using commercially available optical components. Optionally, customized optical components (e.g., custom aspheric lenses) can also be included.

The telecentric illumination optics can include object-side telecentricity, image-side telecentricity, or bi-telecentricity (object-side telecentricity and image-side telecentricity). Inclusion of bi-telecentricity can be preferred.

Multiple projections systems may be provided to address the photohardenable composition, e.g., at one or more selected location(s), simultaneously or sequentially, using the same or different excitation lights. For example, two or more projection systems may be positioned on opposite or adjacent sides of the container, or at any other location relative to each other. For example, when two or more projection systems are used to address the same one or more locations in the volume of the photohardenable composition, the optical projections of excitation light from each of the projection systems may be fully intersecting, partially intersecting, or nonintersecting. It may be desirable for two or more of the optical excitation projections from two or more projection systems to be projected such that at least one of the optical projections (e.g., the second orthogonal projection) is orthogonal to the direction in which the first optical projection is directed.

In methods in accordance with the present invention that include at two or more excitation light projections, optionally one of the two or more optical projections can comprise a plane of light including a major face (which may also be referred to herein as a light sheet). Light sheets can be constructed by means known in the art including, for example, but not limited to, a laser with one or more optical components. For example, a first optical projection comprising a plane of light including a major face, can be generated with a light source and arrangement elements including a Powell lens and one, two, or more optical components (e.g., a combination of lenses and/or mirrors). Other examples of light sheet generation methods include galvanometers, polygon scanners, MEMS scanners, diffractive optical elements, cylindrical lenses, and axicon lenses, with or without additional optical components. Light sources may include lasers, LEDs, and/or thermal (lamp) sources. Optionally one or more of the orthogonal excitation light projections can comprise a light sheet. A light source comprising a laser can be preferred.

In accordance with a still further aspect of the present invention, there is provided a method of forming an object in a volume of a photohardenable composition, the method comprising: (a) providing a volume of the photohardenable composition included within a container wherein at least a portion of the container is optically transparent so that the photohardenable composition is accessible by excitation light; (b) projecting at least two optical projections of excitation light from one or more projection systems into the volume of the photohardenable composition to one or more selected locations in the volume, the at least two optical projections comprising a first optical projection including first excitation light having a first wavelength and a second optical projection including a second excitation light having a second wavelength, wherein the second optical projection is projected from a projection system including telecentric illumination optics arranged in the optical illumination path of the second excitation light for illuminating a projection device for projecting the second optical projection and telecentric projection optics arranged in the optical projection path between the projection device for projecting the second optical projection and the volume of the photohardenable composition, wherein the photohardenable composition is at least partially hardened (e.g., via at least partial polymerization or at least partial crosslinking) at the one or more selected locations in the volume; and (c) optionally repeating step (b) one or more times until the object is partially or fully formed.

Preferably the one or more optical projections of excitation light are directed to one or more locations within the photohardenable composition selected for forming the object.

The telecentric illumination optics can comprise an arrangement of one or more spherical and/or aspherical lenses and/or one or more spherical and/or aspherical mirrors for providing the desired telecentricity. Such arrangements can be constructed by the skilled artisan using commercially available optical components. Optionally, customized optical components (e.g., custom aspheric lenses) can also be included.

The telecentric illumination optics can include object-side telecentricity, image-side telecentricity, or bi-telecentricity (object-side telecentricity and image-side telecentricity). Inclusion of bi-telecentricity can be preferred.

The telecentric projection optics can comprise an arrangement of one or more spherical and/or aspherical lenses and/or one or more spherical and/or aspherical mirrors for providing the desired telecentricity. Such arrangements can be constructed by the skilled artisan using commercially available optical components. Optionally, customized optical components (e.g., custom aspheric lenses) can also be included.

The telecentric projection optics can include object-side telecentricity, image-side telecentricity, or bi-telecentricity (object-side telecentricity and image-side telecentricity). Inclusion of bi-telecentricity can be preferred.

Methods including both illumination telecentric optics and telecentric projection optics can be preferred.

Methods in accordance with the present invention that include both telecentric illumination optics arranged in the optical illumination path of the second excitation light for illuminating a projection device for projecting the second optical projection and telecentric projection optics arranged in the optical projection path between the projection device for projecting the second optical projection and the volume of the photohardenable composition can facilitate the ability to provide for a variable focus lens with adjustable magnification to be included in a telecentric projection lens system in the optical path between the projection device for projecting the optical projection and the container such that size of the printing field in the volume and the feature resolution of the printed objects can be modified by simple adjustment to the zoom position of the variable focus lens; the condition of telecentricity enables the ability to design and implement such a variable magnification (zoom) lens.

Methods in accordance with the present invention that include both telecentric illumination optics arranged in the optical illumination path of the second excitation light for illuminating a projection device for projecting the second optical projection and telecentric projection optics arranged in the optical projection path between the projection device for projecting the second optical projection and the volume of the photohardenable composition can facilitate the ability to exchange or swap out one or more fixed or variable focus telecentric projection lenses included in a projection lens system in the optical path between the projection device for projecting the optical projection and the container with lenses of different fixed or variable (e.g., zoom) magnifications such that size of the printing field in the volume and the feature resolution of the printed objects can be modified; the condition of telecentricity in which the optical pupils of the illumination and projection systems are located at infinity provides for straightforward pupil matching in the optical design which can enable the ability to design and implement such easily swappable lenses.

Methods in accordance with the present invention that include both telecentric illumination optics in the optical illumination path of the excitation light for illuminating the projection device for projecting at least one of one or more optical projections and telecentric projection optics arranged in the optical projection path between the projection device for projecting the at least one of the one or more optical projections and the volume of the photohardenable composition can facilitate the ability to exchange or swap out one or more illumination sources illuminating the projection device such that the wavelength, power, or NA of the light source can be easily modified to improve print quality. The condition of telecentricity in which the optical pupils of the illumination and projection systems are located at infinity provides for straightforward pupil matching in the optical design which can enable the ability to design and implement such easily swappable illumination sources.

Methods in accordance with the present invention that include both telecentric illumination optics arranged in the optical illumination path of the second excitation light for illuminating a projection device for projecting the second optical projection and telecentric projection optics arranged in the optical projection path between the projection device for projecting the second optical projection and the volume of the photohardenable composition can facilitate the use of high numerical aperture illumination and projection; for example, if a DMD is used as the projection device, a numerical aperture in the upper range of DMD capability (0.1-0.2) is possible, enabling higher feature resolution of printed objects; the condition of telecentricity in which the cone of angles incident on the DMD from the illumination optics and reflected from the DMD to the projection optics is uniform across the full area of the DMD and does not require a bias or offset angle that would necessitate a reduced numerical aperture enables high numerical aperture.

Methods in accordance with the present invention that include telecentric projection optics arranged in the optical projection path between the projection device for projecting the second optical projection and the volume of the photohardenable composition (whether or not telecentric illumination optics are also included) can facilitate producing an image with substantially constant magnification over a range of axial depths within the photohardenable composition such that the size of the projected image generated by the optical projection system and the lateral resolution of the projected image generated thereby are maintained over the full width of the first optical projection of excitation light and thus there are reduced and preferably no, or substantially no, distortions introduced to the printed part due to variations in magnification and/or lateral resolution; the condition of telecentricity in which the chief rays of the projection are all parallel can enable the constant magnification condition over the full width of the projection.

Methods in accordance with the present invention that include telecentric illumination optics arranged in the optical illumination path of the second excitation light for illuminating a projection device for projecting the second optical projection (whether or not telecentric projection optics are also included) can facilitate generation by the optical projection system of an image with high uniformity of irradiance over the full optical projection, for example, if a DMD is used as the projection device, greater than 98% uniformity can be achieved, thus enabling higher part accuracy over the full optical projection; the condition of telecentricity in which the cone of angles incident on the DMD from the illumination optics and reflected from the DMD to the projection optics is uniform across the full area of the DMD and can facilitate that the light field interaction with the DMD (which includes interaction with the micromirrors as well as the structure beneath the micromirrors) is uniform across the full area of the DMD, and can enable the condition of high irradiance uniformity over the full projection image.

Methods in accordance with the present invention that include telecentric illumination optics in the optical illumination path of the excitation light for illuminating the projection device for projecting at least one of one or more optical projections (whether or not telecentric projection optics are also included) can facilitate generation by the optical projection system of an image with high uniformity of lateral resolution over the full optical projection, for example, if a DMD is used as the projection device, greater than 98% uniformity can be achieved, which can enable higher part accuracy over the full optical projection. The condition of telecentricity in which the cone of angles incident on the DMD from the illumination optics and reflected from the DMD to the projection optics is uniform across the full area of the DMD can minimize variation in the aberrations from the optical system across the full field and can enable the condition of high lateral resolution uniformity over the full projection image.

Methods in accordance with the present invention that include telecentric projection optics arranged in the optical projection path between the projection device for projecting the second optical projection and the volume of the photohardenable composition (whether or not telecentric illumination optics are also included) can facilitate generation by the optical projection system of an image with low distortion, for example less than 0.1% distortion, thus enabling higher part accuracy over the full optical projection of the image; the condition of telecentricity enables the condition of low distortion over the full projection image.

Methods in accordance with the present invention that include telecentric projection optics arranged in the optical projection path between the projection device for projecting the at least one of the one or more optical projections and the volume of the photohardenable composition (whether or not telecentric illumination optics are also included) can enable a more compact optical design. For example, if a DMD is used as the projection device, the condition of telecentricity in which the cone of angles incident on the DMD from the illumination optics and reflected from the DMD to the projection optics, first, does not require a bias or offset angle that would increase the required size of the projection optics, and second, can allow for the use of a total internal reflection prism which reduces the projection optics back focal distance; both conditions enabling a compact optical design.

Methods in accordance with the present invention that include a first telecentric optics arrangement positioned in the optical illumination path of the second excitation light for illuminating the projection device for projecting the second optical projection and a second telecentric optics arrangement positioned in the optical projection path between the projection device for projecting the second optical projection and the container can facilitate the advantages of both telecentric illumination optics and telecentric projection optics.

Multiple projections systems may be provided to address the photohardenable composition, e.g., at one or more selected locations, simultaneously or sequentially, using the same or different excitation lights. For example, two or more projection systems may be positioned on opposite or adjacent sides of the container, or at any other location relative to each other. For example, when two or more projection systems are used to address the same one or more locations in the volume of the photohardenable composition, the optical projections of excitation light from each of the projection systems may be fully intersecting, partially intersecting, or nonintersecting. It may be desirable for two or more of the optical excitation projections from two or more projection systems to be projected such that at least one of the optical projections (e.g., the second orthogonal projection) is orthogonal to the direction in which the first optical projection is directed.

In methods in accordance with the present invention that include two or more excitation light projections, optionally one of the two or more optical projections can comprise a plane of light including a major face (which may also be referred to herein as a light sheet). Light sheets can be constructed by means known in the art including, for example, but not limited to, a laser with one or more optical components. For example, a first optical projection comprising a plane of light including a major face, can be generated with a light source and arrangement elements including a Powell lens and one, two or more optical components (e.g., a combination of lenses and/or mirrors). Other examples of light sheet generation methods include galvanometers, polygon scanners, MEMS scanners, diffractive optical elements, cylindrical lenses, and axicon lenses, with or without additional optical components. Light sources may include lasers, LEDs, and/or thermal (lamp) sources Optionally one or more of the orthogonal excitation light projections can comprise a light sheet. A light source comprising a laser can be preferred.

Methods in accordance with the present invention can further include separating partially or fully formed objects from the photohardenable composition after formation.

Methods in accordance with the present invention can further include post-processing. Examples of post-processing steps that may be further included in a method in accordance with the invention include, but are not limited to, one or more of the following: washing, post-curing, metrology, drying, and packaging.

Optionally the methods described herein can be carried out in an inert atmosphere.

In the systems and methods in accordance with the present invention, the selection of wavelength(s) of the excitation light for the excitation light projections is preferably made taking into account the photohardenable composition and hardening mechanism being used.

For example, for photohardenable compositions that are hardenable via a hardening mechanism that involves a single wavelength of excitation light, the wavelength of the excitation light projection(s) can be the same. Optionally in such case, an excitation light projection including a different wavelength light can also be included, for example for inhibiting undesired hardening of the photohardenable composition.

In cases where a photohardenable composition is hardenable via a hardening mechanism that involves more than one wavelength of excitation light, the wavelength of the excitation light projections will be selected for projecting excitation light with appropriate wavelengths for the hardening mechanism. Optionally an additional wavelength light can also be used to inhibit undesired hardening of the photohardenable composition.

Methods and systems in accordance with the present invention that include telecentric projection optics preferably produce an image with substantially constant magnification over a range of axial depths within the photohardenable composition. More preferably, methods in accordance with the present invention including telecentric projection optics produce an image with substantially constant magnification over a range of axial depths within the photohardenable composition such that the location of the first optical projection of light may be translated with respect to the second optical projection throughout the volume of the photohardenable composition to generate the object within the volume without the need to translate either the second optical projection or the volume.

Methods in accordance with the present invention that include both telecentric illumination optics and telecentric projection optics can facilitate the ability to provide for a variable focus lens with adjustable magnification to be included in a telecentric projection lens system in the optical path between the projection device for projecting the optical projection and the container such that size of the printing field in the volume and the feature resolution of the printed objects can be modified by simple adjustment to the zoom position of the variable focus lens; the condition of telecentricity can permit the use of a fixed optical stop location within the optical design of a variable focus or zoom lens which can enable the ability to design and implement such a variable magnification (zoom) lens.

Methods in accordance with the present invention that include both telecentric illumination optics and telecentric projection can facilitate the ability to exchange or swap out one or more fixed or variable focus telecentric projection lenses included in a projection lens system in the optical path between the projection device for projecting the optical projection and the container with lenses of different fixed or variable (e.g., zoom) magnifications such that size of the printing field in the volume and the feature resolution of the printed objects can be modified; the condition of telecentricity in which the optical pupils of the illumination and projection systems are located at infinity provides for straightforward pupil matching in the optical design which can enable the ability to design and implement such easily swappable lenses.

Methods in accordance with the present invention that include both telecentric illumination optics in the optical illumination path of the excitation light for illuminating the projection device for projecting at least one of one or more optical projections and telecentric projection optics arranged in the optical projection path between the projection device for projecting the at least one of the one or more optical projections and the volume of the photohardenable composition can facilitate the ability to exchange or swap out one or more illumination sources illuminating the projection device such that the wavelength, power, or NA of the light source can be easily modified to improve print quality. The condition of telecentricity in which the optical pupils of the illumination and projection systems are located at infinity provides for straightforward pupil matching in the optical design which can enable the ability to design and implement such easily swappable illumination sources.

Methods in accordance with the present invention that include both telecentric illumination optics and telecentric projection optics can facilitate the use of high numerical aperture illumination and projection; for example, if a DMD is used as the projection device, a numerical aperture in the upper range of DMD capability (0.1-0.2) is possible, enabling higher feature resolution of printed objects; the condition of telecentricity in which the cone of angles incident on the DMD from the illumination optics and reflected from the DMD to the projection optics is uniform across the full area of the DMD and does not require a bias or offset angle that would necessitate a reduced numerical aperture enables high numerical aperture.

Methods in accordance with the present invention that include telecentric projection optics can facilitate producing an image with substantially constant magnification over a range of axial depths within the photohardenable composition such that the size of the projected image generated by the optical projection system and the lateral resolution of the projected image generated thereby are maintained over the full width of the first optical projection of excitation light and thus there are reduced and preferably no, or substantially no, distortions introduced to the printed part due to variations in magnification and/or lateral resolution; the condition of telecentricity in which the chief rays of the projection are all parallel can enable the constant magnification condition over the full width of the projection.

Methods in accordance with the present invention that include a telecentric illumination optics can facilitate generation by the optical projection system of an image with high uniformity of irradiance over the full optical projection, for example, if a DMD is used as the projection device, greater than 98% uniformity can be achieved, thus enabling higher part accuracy over the full optical projection; the condition of telecentricity in which the cone of angles incident on the DMD from the illumination optics and reflected from the DMD to the projection optics is uniform across the full area of the DMD and can facilitate that the light field interaction with the DMD (which includes interaction with the micromirrors as well as the structure beneath the micromirrors) is uniform across the full area of the DMD, and can enable the condition of high irradiance uniformity over the full projection image.

Methods in accordance with the present invention that include telecentric illumination optics in the optical illumination path of the excitation light for illuminating the projection device for projecting at least one of one or more optical projections (whether or not telecentric projection optics are also included) can facilitate generation by the optical projection system of an image with high uniformity of lateral resolution over the full optical projection, for example, if a DMD is used as the projection device, greater than 98% uniformity can be achieved, which can enable higher part accuracy over the full optical projection. The condition of telecentricity in which the cone of angles incident on the DMD from the illumination optics and reflected from the DMD to the projection optics is uniform across the full area of the DMD can minimize variation in the aberrations from the optical system across the full field and can enable the condition of high lateral resolution uniformity over the full projection image.

Methods in accordance with the present invention that include a telecentric projection optics can facilitate generation by the optical projection system of an image with low distortion, for example less than 0.1% distortion, thus enabling higher part accuracy over the full optical projection of the image; the condition of telecentricity can enable the condition of low distortion over the full projection image.

Methods in accordance with the present invention that include telecentric projection optics arranged in the optical projection path between the projection device for projecting the at least one of the one or more optical projections and the volume of the photohardenable composition (whether or not telecentric illumination optics are also included) can enable a more compact optical design. For example, if a DMD is used as the projection device, the condition of telecentricity in which the cone of angles incident on the DMD from the illumination optics and reflected from the DMD to the projection optics, first, does not require a bias or offset angle that would increase the required size of the projection optics, and second, can allow for the use of a total internal reflection prism which reduces the projection optics back focal distance; both conditions enabling a compact optical design.

In accordance with a still further aspect of the present invention, there is provided a system for forming an object in a volume of a photohardenable composition, the system comprising: one or more projection systems configured for receiving excitation light and projecting one or more optical projections into the volume included in the volume of the photohardenable composition, wherein at least one of the projection systems includes a projection device and one or more telecentric optics arrangements positioned in: (a) the optical illumination path of the excitation light for illuminating the projection device for projecting at least one of the one or more optical projections and/or (b) the optical projection path between the projection device for projecting the at least one of the one or more optical projections and the volume of the photohardenable composition.

The system is preferably further configured to include a container for including the volume of the photohardenable composition. Preferably at least a portion of the container is optically transparent so that the photohardenable composition is accessible by excitation light. A container can optionally be included as a component of the system or can be separately supplied. In either case, it can be desirable for the container to be removable from the system. It can further be desirable for the container to be reusable.

The system can further include one or more lighting sources which are arranged to provide excitation light to the one or more projection systems.

In accordance with a still further aspect of the present invention, there is provided a system for forming an object in a volume of a photohardenable composition, the system comprising: a container adapted to include the volume of the photohardenable composition wherein at least a portion of the container is optically transparent so that the photohardenable composition is accessible by excitation light; and one or more projection systems configured for receiving excitation light and projecting one or more optical projections into the volume included in the container, wherein at least one of the projection systems includes a projection device and one or more telecentric optics arrangements positioned in: (a) the optical illumination path of the excitation light for illuminating the projection device and/or (b) the optical projection path between the projection device and the container.

Optionally, the system can include a telecentric optics arrangement positioned in the optical illumination path of the excitation light for illuminating the projection device for projecting at least one of one or more optical projections (also referred to herein as telecentric illumination optics), a telecentric optics arrangement positioned in the optical projection path between a projection device for projecting an optical projection and the container (also referred to herein as telecentric projection optics), or both telecentric illumination optics and telecentric projection optics.

Systems including both illumination telecentric optics and telecentric projection optics can be preferred.

As discussed above, telecentric optics can comprise an arrangement of one or more spherical and/or aspherical lenses and/or one or more spherical and/or aspherical mirrors for providing the desired telecentricity. Such arrangements can be constructed by the skilled artisan using commercially available optical components. Optionally, customized optical components (e.g., custom aspheric lenses) can also be included.

The telecentric illumination optics and/or the telecentric projection optics included in a system described herein can include object-side telecentricity, image-side telecentricity, or bi-telecentricity (object-side telecentricity and image-side telecentricity). Inclusion of bi-telecentricity can be preferred. The type of telecentricity of the illumination optics and the projection optics can be the same or different. For example, a telecentric illumination optics arrangement can have object-side telecentricity and a telecentric projection optics arrangement can include image-side telecentricity or bi-telecentricity, and vice versa. Preferably both can include bi-telecentricity.

Multiple projections systems may be provided to address the volume of the photohardenable composition, e.g., at one or more selected locations, simultaneously or sequentially, using the same or different excitation lights. For example, two or more projection systems may be positioned on opposite or adjacent sides of the container, or at any other location relative to each other. For example, when two or more projection systems are used to address the same one or more locations in the volume of the photohardenable composition, the optical projections of excitation light from each of the projection systems may be fully intersecting, partially intersecting, or nonintersecting. It may be desirable for two or more of the optical excitation projections from two or more projection systems to be projected such that at least one of the optical projections (e.g., the second orthogonal projection) is orthogonal to the direction in which the first optical projection is directed.

Optionally, one or more light sources for illuminating a projection device are not included as component(s) of a system, but instead can be separately provided. Use of separately provided light sources facilitates the flexibility of being able to readily change light sources with light sources for generating different wavelengths and/or light sources different power capabilities.

A projection system can be configured to project one or more optical projections to one or more selected locations in the volume.

In accordance with a still further aspect of the present invention, there is provided a system for forming an object in a volume of a photohardenable composition, the system comprising: a container adapted to include the volume of the photohardenable composition wherein at least a portion of the container is optically transparent so that the photohardenable composition is accessible by excitation light; one or more lighting sources which are arranged to provide excitation light to one or more projection systems configured for receiving excitation light and projecting one or more optical projections into the volume included in the container, wherein at least one projection system includes a projection device and one or more telecentric optics arrangements positioned in: (a) the optical illumination path between a light source and the projection device and/or (b) the optical projection path between the projection device and the container.

Optionally, the system can include a telecentric optics arrangement positioned in the optical illumination path of the excitation light for illuminating the projection device for projecting at least one of one or more optical projections (also referred to herein as telecentric illumination optics), a telecentric optics arrangement positioned in the optical projection path between a projection device for projecting an optical projection and the container (also referred to herein as telecentric projection optics), or both telecentric illumination optics and telecentric projection optics.

Systems including both illumination telecentric optics and telecentric projection optics can be preferred.

As discussed above, telecentric optics can comprise an arrangement of one or more spherical and/or aspherical lenses and/or one or more spherical and/or aspherical mirrors for providing the desired telecentricity. Such arrangements can be constructed by the skilled artisan using commercially available optical components. Optionally, customized optical components (e.g., custom aspheric lenses) can also be included.

The telecentric illumination optics and/or the telecentric projection optics included in a system described herein can include object-side telecentricity, image-side telecentricity, or bi-telecentricity (object-side telecentricity and image-side telecentricity). Inclusion of bi-telecentricity can be preferred. The type of telecentricity of the illumination optics and the projection optics can be the same or different. For example, a telecentric illumination optics arrangement can have object-side telecentricity and a telecentric projection optics arrangement can include image-side telecentricity or bi-telecentricity, and vice versa. Other telecentricity combinations can be used. Preferably both can include bi-telecentricity.

Multiple projections systems may be provided to address the photohardenable composition, e.g., at one or more selected locations, simultaneously or sequentially, using the same or different excitation lights. For example, two or more projection systems may be positioned on opposite or adjacent sides of the container, or at any other location relative to each other. For example, when two or more projection systems are used to address the same one or more locations in the volume of the photohardenable composition, the optical projections of excitation light from each of the projection systems may be fully intersecting, partially intersecting, or nonintersecting. It may be desirable for two or more of the optical excitation projections from two or more projection systems to be projected such that at least one of the optical projections (e.g., the second orthogonal projection) is orthogonal to the direction in which the first optical projection is directed.

Light sources included in the system are preferably selected taking into consideration the photohardenable liquid being used and the hardening mechanism therefor. Such considerations include the wavelength(s) preferred for the particular photohardening mechanism and power levels preferred therefor. Selection of suitable light sources is within the skill of the person of ordinary skill in the relevant art.

A projection system can be configured to project one or more optical projections to one or more selected locations in the volume.

Systems in accordance with the present invention that include telecentric optics arrangements positioned both in: (a) the optical illumination path between a light source and a projection device for projecting at least one of the one or more optical projections and (b) the optical projection path between the projection device for projecting the at least one of the one or more optical projections and the container can facilitate the ability to provide for a variable focus lens with adjustable magnification to be included in a telecentric projection lens system in the optical path between the projection device for projecting the optical projection and the container such that size of the printing field in the volume and the feature resolution of the printed objects can be modified by simple adjustment to the zoom position of the variable focus lens; the condition of telecentricity enables the ability to design and implement such a variable magnification (zoom) lens. As discussed above, the condition of telecentricity can permit the use of a fixed optical stop location within the optical design of a variable focus or zoom lens which enables the ability to design and implement such a variable magnification (zoom) lens.

Systems in accordance with the present invention that include telecentric optics arrangements positioned both in: (a) the optical illumination path between a light source and a projection device for projecting at least one of the one or more optical projections and (b) the optical projection path between the projection device for projecting the at least one of the one or more optical projections and the container can facilitate the ability to exchange or swap out one or more fixed or variable focus telecentric projection lenses included in a projection lens system in the optical path between the projection device for projecting the optical projection and the container with lenses of different fixed or variable (e.g., zoom) magnifications such that size of the printing field in the volume and the feature resolution of the printed objects can be modified. As discussed above, the condition of telecentricity in which the optical pupils of the illumination and projection systems are located at infinity provides for straightforward pupil matching in the optical design can enable the ability to design and implement such easily swappable lenses.

Systems in accordance with the present invention that include both telecentric illumination optics in the optical illumination path of the excitation light for illuminating the projection device for projecting at least one of one or more optical projections and telecentric projection optics arranged in the optical projection path between the projection device for projecting the at least one of the one or more optical projections and the volume of the photohardenable composition can facilitate the ability to exchange or swap out one or more illumination sources illuminating the projection device such that the wavelength, power, or NA of the light source can be easily modified to improve print quality; the condition of telecentricity in which the optical pupils of the illumination and projection systems are located at infinity provides for straightforward pupil matching in the optical design which can enable the ability to design and implement such easily swappable illumination sources.

Systems in accordance with the present invention that include telecentric optics arrangements positioned both in: (a) the optical illumination path between a light source and a projection device for projecting at least one of the one or more optical projections and (b) the optical projection path between the projection device for projecting the at least one of the one or more optical projections and the container can facilitate the use of high numerical aperture illumination and projection; for example, if a DMD is used as the projection device, a numerical aperture in the upper range of DMD capability (0.1-0.2) is possible, enabling higher feature resolution of printed objects; the condition of telecentricity in which the cone of angles incident on the DMD from the illumination optics and reflected from the DMD to the projection optics is uniform across the full area of the DMD and does not require a bias or offset angle that would necessitate a reduced numerical aperture enables high numerical aperture.

Systems in accordance with the present invention that include telecentric optics arrangements positioned the optical projection path between the projection device for projecting the at least one of the one or more optical projections and the container (whether or not telecentric illumination optics are also included) can facilitate producing an image with substantially constant magnification over a range of axial depths within the photohardenable composition such that the size of the projected image generated by the optical projection system and the lateral resolution of the projected image generated thereby are maintained over the full width of the first optical projection of excitation light and thus there are reduced and preferably no, or substantially no, distortions introduced to the printed part due to variations in magnification and/or lateral resolution. As discussed above, the condition of telecentricity in which the chief rays of the projection are all parallel can enable the constant magnification condition over the full width of the projection.

Systems in accordance with the present invention that include telecentric optics arrangements positioned the optical projection path between a light source and a projection device for projecting at least one of the one or more optical projections (whether or not telecentric projection optics are also included) can facilitate generation by the optical projection system of an image with high uniformity of irradiance over the full optical projection, for example, if a DMD is used as the projection device, greater than 98% uniformity can be achieved, thus enabling higher part accuracy over the full optical projection; the condition of telecentricity in which the cone of angles incident on the DMD from the illumination optics and reflected from the DMD to the projection optics is uniform across the full area of the DMD and can facilitate that the light field interaction with the DMD (which includes interaction with the micromirrors as well as the structure beneath the micromirrors) is uniform across the full area of the DMD, and can enable the condition of high irradiance uniformity over the full projection image.

Systems in accordance with the present invention that include telecentric illumination optics in the optical illumination path of the excitation light for illuminating the projection device for projecting at least one of one or more optical projections (whether or not telecentric projection optics are also included) can facilitate generation by the optical projection system of an image with high uniformity of lateral resolution over the full optical projection, for example, if a DMD is used as the projection device, greater than 98% uniformity can be achieved, which can enable higher part accuracy over the full optical projection; the condition of telecentricity in which the cone of angles incident on the DMD from the illumination optics and reflected from the DMD to the projection optics is uniform across the full area of the DMD can minimize variation in the aberrations from the optical system across the full field and can enable the condition of high lateral resolution uniformity over the full projection image.

Systems in accordance with the present invention that include telecentric projection optics arranged in the optical projection path between the projection device for projecting the at least one of the one or more optical projections and the volume of the photohardenable composition (whether or not telecentric illumination optics are also included) can enable a more compact optical design. For example, if a DMD is used as the projection device, the condition of telecentricity in which the cone of angles incident on the DMD from the illumination optics and reflected from the DMD to the projection optics, first, does not require a bias or offset angle that would increase the required size of the projection optics, and second, can allow for the use of a total internal reflection prism which reduces the projection optics back focal distance; both conditions enabling a compact optical design.

Systems in accordance with the present invention that include telecentric optics arrangements positioned the optical projection path between the projection device for projecting the at least one of the one or more optical projections and the container (whether or not telecentric illumination optics are also included) can facilitate generation by the optical projection system of an image with low distortion, for example less than 0.1% distortion, thus enabling higher part accuracy over the full optical projection of the image. As discussed above, the condition of telecentricity in which the chief rays of the projection are all parallel enables the condition of low distortion over the full projection image.

Systems in accordance with the present invention that include a first telecentric optics arrangement positioned in the optical illumination path of the excitation light for illuminating the projection device for projecting at least one of the one or more optical projections and a second telecentric optics arrangement positioned in the optical projection path between the projection device for projecting the optical projection and the volume can facilitate the advantages of both telecentric illumination optics and telecentric projection optics.

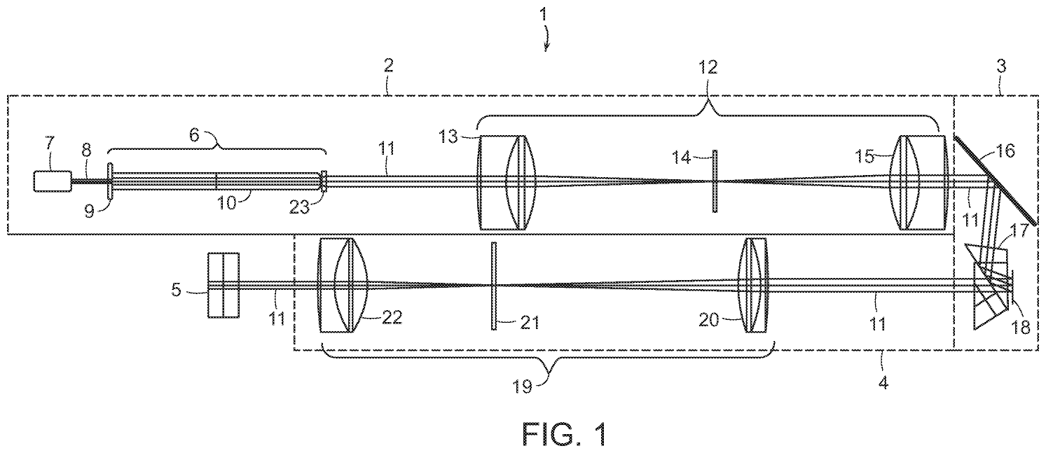

FIGS. 1-4 and the following description thereof provide examples of the methods and systems described herein.

FIG. 1 depicts an example of a system 1 in accordance with the present invention that includes a projection system including telecentric illumination optics and telecentric projection optics. As depicted, the example of the system includes an illumination section 2, a projection device 3, a projection section 4, and a container 5. The depicted example of the illumination section 2 includes a collimated light source 7. The collimated rays 8 emitting from the light source 7 enter homogenizer optics 6. As depicted, the homogenizer optics 6 include a diffuser 9, an integrating rod 10, and an optional field stop aperture 23. Examples of diffusers 9 include, but are not limited to, ground glass diffusers and engineered (diffraction based) diffusers. Examples of integrating rods 10 include, but are not limited to, mirrored tunnels and solid glass rods. The rays 11 emitted from the integrating rod 10 having substantially uniform irradiance over the aperture of the rod are in optical communication with telecentric illumination optics 12 which are depicted in the example as bi-telecentric illumination optics (including an arrangement including two lenses 13, 15, and an optional iris 14). Examples of lenses 13 and 15 include, but are not limited to, achromatic doublets with focal lengths in the range 50 mm to 500 mm, available off the shelf from Edmund Optics. Other examples of such lenses can have focal lengths in ranges from 50 mm to 200 mm, 50 mm to 300 mm, 50 mm to 400 mm, and other ranges within the range of 50 mm to 500 mm. The depicted example of a projection device 3 includes an arrangement of a projection device 18 (e.g., a DMD) in combination with a total internal reflection (also referred to as “TIR”) prism 17 and turn mirror 16. The depicted example of a projection section 4 includes telecentric projection optics 19 which are depicted in the example as bi-telecentric projection optics (including an arrangement including two lenses 20, 22 and an optional iris 21). Examples of lenses 20, 22 include, but are not limited to, achromatic doublets with focal lengths in the range 50 mm to 500 mm, available off the shelf from Edmund Optics. Other examples of such lenses can have focal lengths in ranges from 50 mm to 200 mm, 50 mm to 300 mm, 50 mm to 400 mm, and other ranges within the range of 50 mm to 500 mm. Container 5 is positioned for receiving an optical projection projected from the projection system. As discussed herein, the container is configured to include a volume of a photohardenable composition; at least a portion of the container is optically transparent so that the photohardenable composition is accessible by an optical projection of excitation light. The telecentricity is shown by the chief rays 11 of the illumination and projection light being parallel to the optical path thereof when entering and exiting the bi-telecentric lens systems.

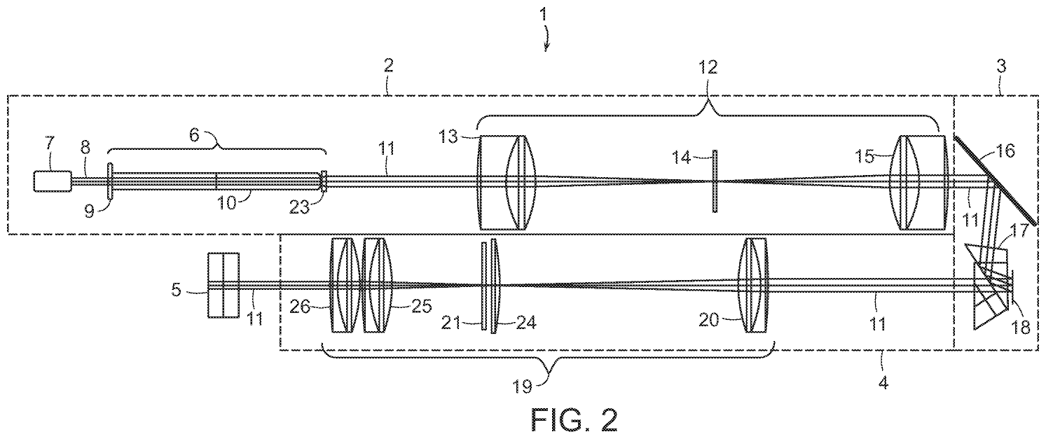

FIG. 2 depicts another example of a system 1 in accordance with the present invention that includes a projection system including telecentric illumination optics and telecentric projection optics. As depicted, the example of the system includes an illumination section 2, a projection device 3, a projection section 4, and a container 5. The depicted example of the illumination section 2 includes a collimated light source 7. The collimated rays 8 emitting from the light source 7 entering homogenizer optics 6. As depicted, the homogenizer optics 6 include a diffuser 9, integrating rod 10, and an optional field stop aperture 23. Examples of diffusers 9 include, but are not limited to, ground glass diffusers and engineered (diffraction based) diffusers. Examples of integrating rods 10 include, but are not limited to, mirrored tunnels and solid glass rods. The rays 11 emitted from the integrating rod 10 having substantially uniform irradiance over the aperture of the rod are in optical communication with the illumination optics 12 which are depicted in the example as bi-telecentric illumination optics (including an arrangement including two lenses 13, 15 and an optional iris 14). Examples of diffuser 9 are ground glass diffusers and engineered (diffraction based) diffusers. Examples of integrating rod 10 are mirrored tunnels and solid glass rods. Examples of lenses 13, 15 include, but are not limited to, are achromatic doublets with focal lengths in the range 50 mm to 500 mm, available off the shelf from Edmund Optics. Other examples of such lenses can have focal lengths in ranges from 50 mm to 200 mm, 50 mm to 300 mm, 50 mm to 400 mm, and other ranges within the range of 50 mm to 500 mm. The depicted example of a projection device 3 includes an arrangement of a projection device 18 (e.g., a DMD) in combination with a TIR prism 17 and turn mirror 16. The depicted example of a projection section 4 includes projection optics 19 which are depicted in the example as bi-telecentric projection optics (including an arrangement including three lenses 20, 25, 26, an optional iris 21, and an optional aspheric lens 24). Examples of lenses 20, 25, 26 include, but are not limited to, achromatic doublets with focal lengths in the range 50 mm to 500 mm, available off the shelf from Edmund Optics. Other examples of such lenses can have focal lengths in ranges from 50 mm to 200 mm, 50 mm to 300 mm, 50 mm to 400 mm, and other ranges within the range of 50 mm to 500 mm. In this example, lens 22 from FIG. 1 has been replaced with lenses 25, 26, each with approximately twice the focal length of lens 22, in order to reduce spherical aberration and thus to provide improved lateral resolution at the image plane within the container 5. Optional aspheric lens 24 is placed at or near the optical stop of the projection optics and has spherical and aspherical curvature terms selected to further reduce spherical aberration and thus provide further improved lateral resolution at the image plane within container 5. Container 5 is positioned for receiving an optical projection projected from the projection system. As discussed herein, the container is configured to include a volume of a photohardenable composition; at least a portion of the container is optically transparent so that the photohardenable composition is accessible by an optical projection of excitation light. The telecentricity is shown by the chief rays of the illumination and projection light 11 being parallel to the optical path thereof when entering and exiting the bi-telecentric lens systems.

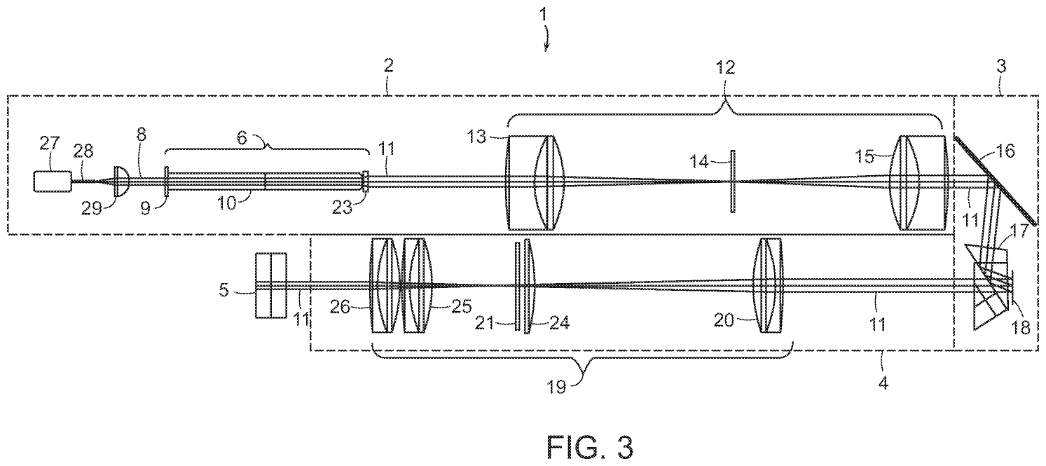

FIG. 3 depicts another example of a system 1 in accordance with the present invention including a projection system that includes telecentric illumination optics and telecentric projection optics. As depicted, the example of the system includes an illumination section 2, a projection device 3, a projection section 4, and a container 5. The depicted example of the illumination section 2 includes a fiber coupled light source 27, an optical fiber 28, and a collimating lens 29, the collimated rays 8 emitting from the collimating lens 29 entering homogenizer optics 6. As depicted, the homogenizer optics 6 include a diffuser 9, an integrating rod 10, and an optional field stop aperture 23. Examples of diffuser 9 are ground glass diffusers and engineered (diffraction based) diffusers. Examples of integrating rod 10 are mirrored tunnels and solid glass rods. The rays 11 emitted from the integrating rod 10 having substantially uniform irradiance over the aperture of the rod and are in optical communication with the bi-telecentric illumination optics 12 (including an arrangement including two lenses 13, 15 and an optional iris 14). Examples of lenses 13, 15 include achromatic doublets with focal lengths in the range 50 mm to 500 mm, available off the shelf from Edmund Optics. Other examples of such lenses can have focal lengths in ranges from 50 mm to 200 mm, 50 mm to 300 mm, 50 mm to 400 mm, and other ranges within the range of 50 mm to 500 mm. The depicted example of a projection device 3 includes an arrangement of a projection device 18 (e.g., a DMD) in combination with a TIR prism 17 and turn mirror 16. The depicted example of a projection section 4 includes telecentric projection optics 19 which are depicted in the example as bi-telecentric projection optics (including an arrangement including three lenses 20, 25, 26, an optional iris 21, and an optional aspheric lens 24). Examples of lenses 20, 25, 26 include, but are not limited to, achromatic doublets with focal lengths in the range 50 mm to 500 mm, available off the shelf from Edmund Optics. Other examples of such lenses can have focal lengths in ranges from 50 mm to 200 mm, 50 mm to 300 mm, 50 mm to 400 mm, and other ranges within the range of 50 mm to 500 mm. In this example, lens 22 from FIG. 1 has been replaced with lenses 25, 26, each with approximately twice the focal length of lens 22, in order to reduce spherical aberration and thus to provide improved lateral resolution at the image plane within the container 5. Optional aspheric lens 24 is placed at or near the aperture stop of the projection optics and has spherical and aspherical curvature terms selected to further reduce spherical aberration and thus provide further improved lateral resolution at the image plane within container 5. Container 5 is positioned for receiving an optical projection projected from the projection system. As discussed herein, the container is configured to include a volume of a photohardenable composition; at least a portion of the container is optically transparent so that the photohardenable composition is accessible by an optical projection of excitation light. The telecentricity is shown by the chief rays of the illumination and projection light 11 being parallel to the optical path thereof when entering and exiting the bi-telecentric lens systems.

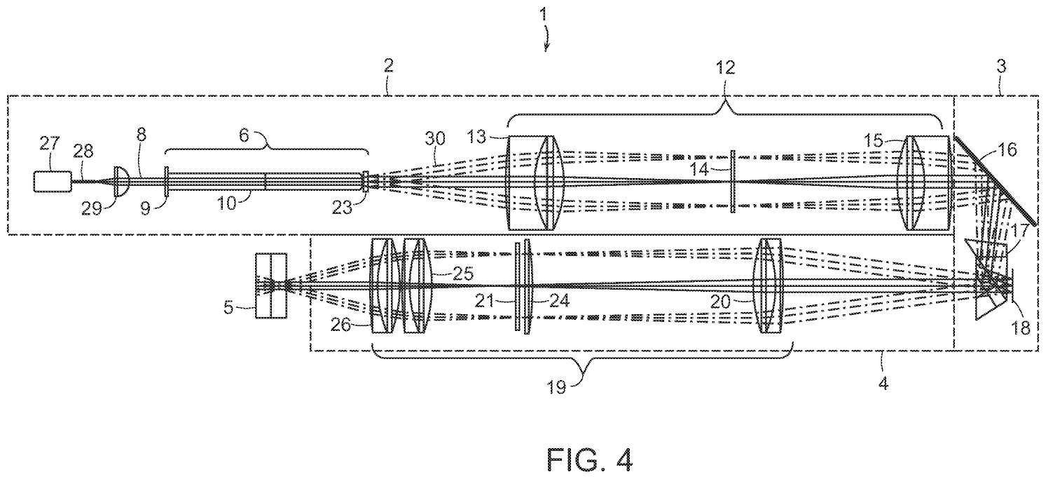

FIG. 4 depicts the example of a system 1 that is depicted in FIG. 3, but with the addition of the marginal rays 30 drawn to illustrate the full imaging properties of the bi-telecentric optics. In particular, the marginal rays 30 illustrate the image locations at the exit of the homogenizer optics 6, at the projection device 18, and within the container 5, and the marginal rays 30 also illustrate the required sizes of all optical elements within the projection system.

A system described herein can optionally include an integrating rod 10 in the homogenizer portion of the illumination optics section 6 to improve illumination uniformity across the surface of the projection device 18, for example a DMD. The integrating rod can be a hollow reflective tunnel or a solid glass rod. The system can optionally include a diffuser 9 in the homogenizer portion of the illumination optics section 6. The diffuser profile of scatter vs. angle is a design parameter that is chosen in conjunction with the integrating rod width, height, and length, the f/# of the telecentric illumination optics, and the magnification of the telecentric illumination optics to establish the spatial extent, uniformity, and numerical aperture of the illumination image at the projection device face.

A system described herein can optionally include a field stop aperture 23 that can be placed at an intermediate image location (e.g., at a field stop) and can be used to control the spatial extent of the illumination pattern on the projection device. For example, in typical practice, the image generated by the illumination section may be intentionally sized larger than the face of the projection device as falloff in intensity is expected at the corners. The field stop aperture may then be used to limit the portion of the illumination image generated by the integrating rod to only that central portion of the image that has best uniformity, so that only that portion with best uniformity is imaged onto the projection device. This permits high uniformity at the projection device and eliminates unwanted light that would cause optical noise for loss of contrast.

A system described herein can optionally include an iris 14 that can be placed at the intermediate aperture stop location of telecentric illumination optics 12 and can be used to limit the angular range (numerical aperture) of the illumination reaching the projection device. A system can also optionally include an iris 21 that can be placed at the intermediate aperture stop location of telecentric projection optics 19 and can be used to limit the angular range of the illumination reaching the image plane within the container 5. Optional irises 12 and 19 can be used individually or in combination to control the tradeoff between system efficiency, lateral resolution, and depth of focus of the projection image within the resin. This method of adjusting numerical aperture is “on the fly” adjustable, as opposed to the fixed design of integrating rod size and diffuser angular profile.

A projection system can optionally include a turn mirror 16 on a fixed or kinematic mount. This can be particularly useful when a TIR prism 17 is included as the turn mirror can permit highly precise directing of the illumination light to the TIR prism input face.

Inclusion of a TIR prism 17 can be preferred to facilitate a TIR method of separating the illumination and projection rays to enable higher numerical aperture (NA) (e.g., greater than 0.1), better spatial and uniformity at the projection device, and a more compact optical design. Alternative prism forms such as a RTIR (Reverse Total Internal Reflection) prism, well known in the art, may optionally be included in the alternative.

The optional inclusion of an asphere 24, located at or near the aperture stop of the telecentric projection optics 19, is used to correct for aberrations in the projection optical system, in particular spherical aberration, to permit for improved lateral optical resolution.

In the methods and systems in accordance with the present invention, optionally the container can be moved (for example, with use of stage translatable in the x, y, and z directions) relative to the position of the projection system for selectively locating or positioning the optical projection to a selected located in the volume. Optionally, in the alternative, a projection system can be moved (for example, with use of stage translatable in the x, y, and z directions) relative to the position of the container for selectively locating or positioning the optical projection to a selected located in the volume.

In accordance with a still further aspect of the present invention, there is provided a system for forming an object in a volume of a photohardenable composition, the system comprising: one or more projection systems configured for receiving excitation light and projecting two or more optical projections into the volume of the photohardenable composition, the two or more optical projections including a first optical projection including a first excitation light having a first wavelength and a second optical projection including a second excitation light having a second wavelength, wherein at least one of the projection systems includes a projection device and one or more telecentric optics arrangements positioned in: (a) the optical illumination path of the second excitation light for illuminating the projection device for projecting the second optical projection and/or (b) the optical projection path between the projection device for projecting the second optical projection and the volume of the photohardenable composition.

The system is preferably further configured to include a container for including the volume of the photohardenable composition. The container preferably includes at least one or more portions that are optically transparent so that the photohardenable composition is accessible by excitation light. A container can optionally be included as a component of the system or can be separately supplied. In either case, it can be desirable for the container to be removable from the system. It can further be desirable for the container to be reusable.

The system can further include two or more lighting sources which are arranged to provide first excitation light including light having a first wavelength and second excitation light including light having a second wavelength to one or more projection systems.

In accordance with a still further aspect of the present invention, there is provided a system for forming an object in a volume of a photohardenable composition, the system comprising: a container adapted to include the volume of the photohardenable composition wherein at least a portion of the container is optically transparent so that the photohardenable composition is accessible by excitation light; one or more projection systems configured for receiving excitation light and projecting two or more optical projections into the volume included in the container, the two or more optical projections including a first optical projection including first excitation light having a first wavelength and a second optical projection including second excitation light having a second wavelength, wherein at least one of the projection systems includes a projection device and one or more telecentric optics arrangements positioned in: (a) the optical illumination path of the second excitation light for illuminating the projection device for projecting the second optical projection and/or (b) the optical projection path between the projection device for projecting the second optical projection and the container.

Optionally, the system can include a telecentric optics arrangement positioned in the optical illumination path of the second excitation light for illuminating the projection device for projecting the second optical projection (also referred to herein as telecentric illumination optics), a telecentric optics arrangement positioned in the optical projection path between the projection device for projecting the second optical projection and the container (also referred to herein as telecentric projection optics), or both telecentric illumination optics and telecentric projection optics.

Systems including both illumination telecentric optics and telecentric projection optics can be preferred.

As discussed above, telecentric optics can comprise an arrangement of one or more spherical and/or aspherical lenses and/or one or more spherical and/or aspherical mirrors for providing the desired telecentricity. Such arrangements can be constructed by the skilled artisan using commercially available optical components. Optionally, customized optical components (e.g., custom aspheric lenses) can also be included.

The telecentric illumination optics and/or the telecentric projection optics included in a system described herein can include object-side telecentricity, image-side telecentricity, or bi-telecentricity (object-side telecentricity and image-side telecentricity). Inclusion of bi-telecentricity can be preferred. The type of telecentricity of the illumination optics and the projection optics can be the same or different. For example, a telecentric illumination optics arrangement can have object-side telecentricity and a telecentric projection optics arrangement can include image-side telecentricity or bi-telecentricity, and vice versa. Preferably both can include bi-telecentricity.

Multiple projections systems may be provided to address the photohardenable composition, e.g., at one or more selected location(s), simultaneously or sequentially, using the same or different excitation lights. For example, two or more projection systems may be positioned on opposite or adjacent sides of the container, or at any other location relative to each other. For example, when two or more projection systems are used to address the same one or more locations in the volume of the photohardenable composition, the optical projections of excitation light from each of the projection systems may be fully intersecting, partially intersecting, or nonintersecting. It may be desirable for two or more of the optical excitation projections from two or more projection systems to be projected such that at least one of the optical projections (e.g., the second orthogonal projection) is orthogonal to the direction in which the first optical projection is directed.

Optionally, one or more light sources for illuminating a projection device are not included in a projection system, but instead are separately provided prior to use. Use of separately provided light sources positioned to illuminate the one or more projection devices can facilitate the flexibility of being able to readily change light sources with light sources for generating different wavelengths and/or light sources different power capabilities.

In accordance with a still further aspect of the present invention, there is provided a system for forming an object in a volume of a photohardenable composition, the system comprising: a container adapted to include the volume of the photohardenable composition wherein at least a portion of the container is optically transparent so that the photohardenable composition is accessible by excitation light; two or more lighting sources which are arranged to provide first excitation light including light having a first wavelength and second excitation light including light having a second wavelength to one or more projection systems; and one or more projection systems configured for receiving the first excitation light and the second excitation light and projecting two or more optical projections into the volume included in the container, the two or more optical projections including a first optical projection including the first excitation light and a second optical projection including the second excitation light, wherein at least one of the projection systems includes a projection device and one or more telecentric optics arrangements positioned in: (a) the optical illumination path between a light source for generating second excitation light and the projection device for projecting the second optical projection and/or (b) the optical projection path between the projection device for projecting the second optical projection and the container.

Optionally, the system can include a telecentric optics arrangement positioned in the optical illumination path of the second excitation light for illuminating the projection device for projecting the second optical projection (also referred to herein as telecentric illumination optics), a telecentric optics arrangement positioned in the optical projection path between the projection device for projecting the second optical projection and the container (also referred to herein as telecentric projection optics), or both telecentric illumination optics and telecentric projection optics.

Systems including both illumination telecentric optics and telecentric projection optics can be preferred.

As discussed above, telecentric optics can comprise an arrangement of one or more spherical and/or aspherical lenses and/or one or more spherical and/or aspherical mirrors for providing the desired telecentricity. Such arrangements can be constructed by the skilled artisan using commercially available optical components. Optionally, customized optical components (e.g., custom aspheric lenses) can also be included.

The telecentric illumination optics and/or the telecentric projection optics included in a system described herein can include object-side telecentricity, image-side telecentricity, or bi-telecentricity (object-side telecentricity and image-side telecentricity). Inclusion of bi-telecentricity can be preferred. The type of telecentricity of the illumination optics and the projection optics can be the same or different. For example, a telecentric illumination optics arrangement can have object-side telecentricity and a telecentric projection optics arrangement can include image-side telecentricity or bi-telecentricity, and vice versa. Preferably both can include bi-telecentricity.

Multiple projections systems may be provided to address the volume of the photohardenable composition, e.g., at one or more selected locations, simultaneously or sequentially, using the same or different excitation lights. For example, two or more projection systems may be positioned on opposite or adjacent sides of the container, or at any other location relative to each other. For example, when two or more projection systems are used to address the same one or more locations in the volume of the photohardenable composition, the optical projections of excitation light from each of the projection systems may be fully intersecting, partially intersecting, or nonintersecting. It may be desirable for two or more of the optical excitation projections from two or more projection systems to be projected such that at least one of the optical projections (e.g., the second orthogonal projection) is orthogonal to the direction in which the first optical projection is directed.

Systems in accordance with the present invention that include a telecentric optics arrangement positioned in each of: (a) the optical illumination path between a light source for generating second excitation light and a projection device for projecting the second optical projection and (b) the optical projection path between the projection device for projecting the second optical projection and the container can facilitate the ability to provide for a variable focus lens with adjustable magnification to be included in a telecentric projection lens system in the optical path between the projection device for projecting the optical projection and the container such that size of the printing field in the volume and the feature resolution of the printed objects can be modified by simple adjustment to the zoom position of the variable focus lens; the condition of telecentricity can permit the use of a fixed optical stop location within the optical design of a variable focus or zoom lens which enables the ability to design and implement such a variable magnification (zoom) lens.

Systems in accordance with the present invention that include a telecentric optics arrangement positioned in each of: (a) the optical illumination path between a light source for generating second excitation light and a projection device for projecting the second optical projection and (b) the optical projection path between the projection device for projecting the second optical projection and the container can facilitate the ability to exchange or swap out one or more fixed or variable focus telecentric projection lenses included in a projection lens system in the optical path between the projection device for projecting the optical projection and the container with lenses of different fixed or variable (e.g., zoom) magnifications such that size of the printing field in the volume and the feature resolution of the printed objects can be modified; the condition of telecentricity in which the optical pupils of the illumination and projection systems are located at infinity provides for straightforward pupil matching in the optical design which can enable the ability to design and implement such easily swappable lenses.

Systems in accordance with the present invention that include both telecentric illumination optics in the optical illumination path of the excitation light for illuminating the projection device for projecting at least one of one or more optical projections and telecentric projection optics arranged in the optical projection path between the projection device for projecting the at least one of the one or more optical projections and the volume of the photohardenable composition can facilitate the ability to exchange or swap out one or more illumination sources illuminating the projection device such that the wavelength, power, or NA of the light source can be easily modified to improve print quality. The condition of telecentricity in which the optical pupils of the illumination and projection systems are located at infinity provides for straightforward pupil matching in the optical design which can enable the ability to design and implement such easily swappable illumination sources.

Systems in accordance with the present invention that include telecentric optics arrangements positioned in each of: (a) the optical illumination path between a light source for generating second excitation light and a projection device for projecting the second optical projection and (b) the optical projection path between the projection device for projecting the second optical projection and the volume of photohardenable composition can facilitate the use of high numerical aperture illumination and projection; for example, if a DMD is used as the projection device, a numerical aperture in the upper range of DMD capability (0.1-0.2) is possible, enabling higher feature resolution of printed objects; the condition of telecentricity in which the cone of angles incident on the DMD from the illumination optics and reflected from the DMD to the projection optics is uniform across the full area of the DMD and does not require a bias or offset angle that would necessitate a reduced numerical aperture enables high numerical aperture.

Systems in accordance with the present invention that include a telecentric optics arrangement positioned in the optical projection path between the projection device for projecting the second optical projection and the container (whether or not telecentric illumination optics are also included) can facilitate producing an image with substantially constant magnification over a range of axial depths within the photohardenable composition such that the size of the projected image generated by the optical projection system and the lateral resolution of the projected image generated thereby are maintained over the full width of the first optical projection of excitation light; the condition of telecentricity enables the constant magnification condition over the full width of the projection.

Systems in accordance with the present invention that include telecentric optics arrangements positioned in the optical illumination path between a light source for generating second excitation light and a projection device for projecting the second optical projection (whether or not telecentric projection optics are also included) can facilitate generation by the optical projection system of an image with high uniformity of irradiance over the full optical projection, for example, if a DMD is used as the projection device, greater than 98% uniformity can be achieved, thus enabling higher part accuracy over the full optical projection; the condition of telecentricity in which the cone of angles incident on the DMD from the illumination optics and reflected from the DMD to the projection optics is uniform across the full area of the DMD and can facilitate that the light field interaction with the DMD (which includes interaction with the micromirrors as well as the structure beneath the micromirrors) is uniform across the full area of the DMD, and can enable the condition of high irradiance uniformity over the full projection image.

Systems in accordance with the present invention that include telecentric illumination optics in the optical illumination path of the excitation light for illuminating the projection device for projecting at least one of one or more optical projections (whether or not telecentric projection optics are also included) can facilitate generation by the optical projection system of an image with high uniformity of lateral resolution over the full optical projection, for example, if a DMD is used as the projection device, greater than 98% uniformity can be achieved, which can enable higher part accuracy over the full optical projection. The condition of telecentricity in which the cone of angles incident on the DMD from the illumination optics and reflected from the DMD to the projection optics is uniform across the full area of the DMD can minimize variation in the aberrations from the optical system across the full field and can enable the condition of high lateral resolution uniformity over the full projection image.

Systems in accordance with the present invention that include telecentric optics arrangements positioned the optical projection path between the projection device for projecting the at least one of the one or more optical projections and the container (whether or not telecentric illumination optics are also included) can facilitate generation by the optical projection system of an image with low distortion, for example less than 0.1% distortion, thus enabling higher part accuracy over the full optical projection of the image. As discussed above, the condition of telecentricity in which the chief rays of the projection are all parallel enables the condition of low distortion over the full projection image.

Systems in accordance with the present invention that include a telecentric optics arrangement positioned in the optical projection path between the projection device for projecting the second optical projection and the container (whether or not telecentric illumination optics are also included) (whether or not telecentric illumination optics are also included) can facilitate generation by the optical projection system of an image with low distortion, for example less than 0.1% distortion, thus enabling higher part accuracy over the full optical projection of the image; the condition of telecentricity enables the condition of low distortion over the full projection image.

Systems in accordance with the present invention that include telecentric projection optics arranged in the optical projection path between the projection device for projecting the at least one of the one or more optical projections and the volume of the photohardenable composition (whether or not telecentric illumination optics are also included) can enable a more compact optical design. For example, if a DMD is used as the projection device, the condition of telecentricity in which the cone of angles incident on the DMD from the illumination optics and reflected from the DMD to the projection optics, first, does not require a bias or offset angle that would increase the required size of the projection optics, and second, can allow for the use of a total internal reflection prism which reduces the projection optics back focal distance; both conditions enabling a compact optical design.

Systems in accordance with the present invention that include telecentric optics arrangements positioned in each of: (a) the optical illumination path between a light source for generating second excitation light and a projection device for projecting the second optical projection and (b) the optical projection path between the projection device for projecting the second optical projection and the container can facilitate the advantages of both telecentric illumination optics and telecentric projection optics.

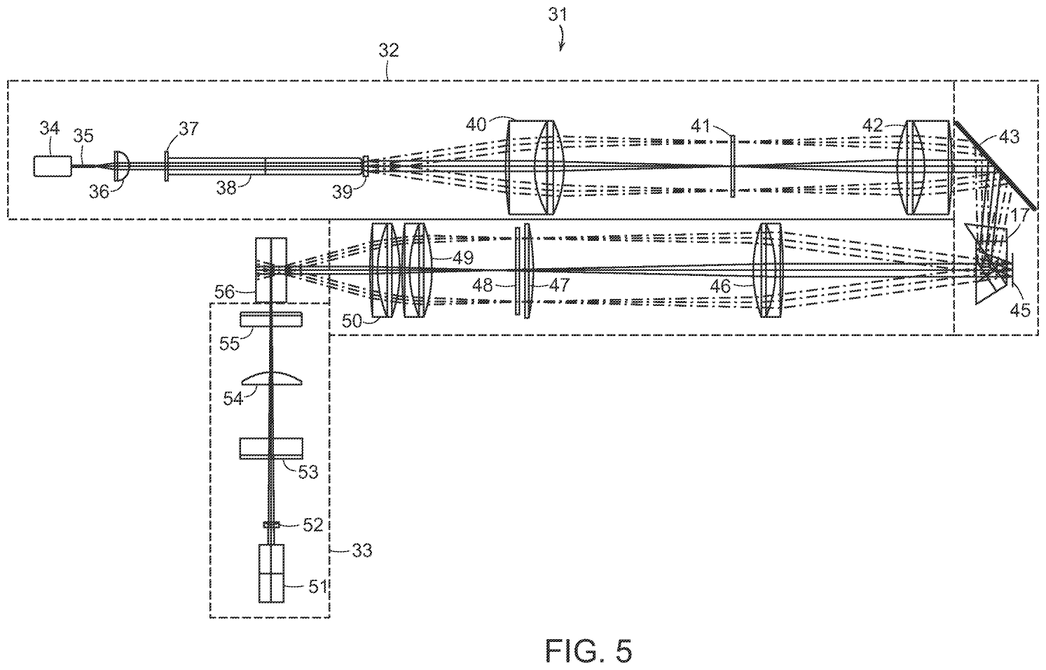

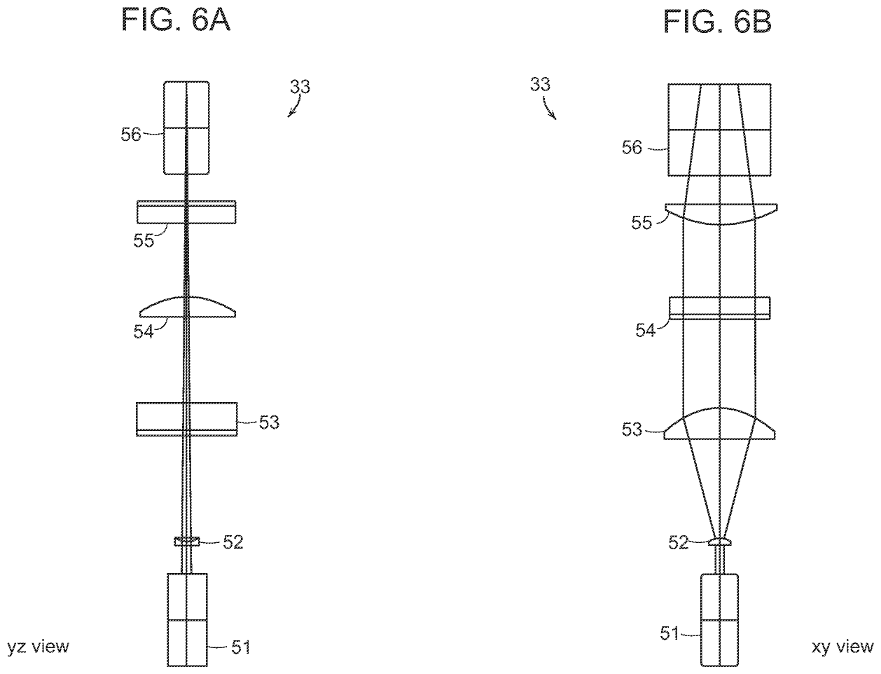

FIGS. 5, 6A, and 6B and the following description thereof provide additional examples of the methods and systems described herein.

FIG. 5 depicts an example of a system 1 in accordance with the present invention. The depicted system 31 includes a first projection system 33 and second projection system 32. The second projection system includes telecentric illumination optics and telecentric projection optics, depicted in the example as bi-telecentric illumination optics and bi-telecentric projection optics. As depicted, the example of the second system includes an illumination section including bi-telecentric illumination optics and a fiber coupled light source 34 for generating second excitation light, optical fiber 35, and collimating lens 36. The collimated rays emitting from the collimating lens 36 enter homogenizer optics including a diffuser 37, integrating rod 38, and an optional field stop aperture 39. Examples of diffusers include, but are not limited to, ground glass diffusers and engineered (diffraction based) diffusers. Examples integrating rods include, but are not limited to, mirrored tunnels and solid glass rods. The rays emitted from the integrating rod having substantially uniform irradiance over the aperture of the rod are in optical communication with telecentric illumination optics (including an arrangement including two lenses 40, 42 and an optional iris 41). Examples of lenses 40, 42 include, but are not limited to, achromatic doublets with focal lengths in the range 50 mm to 500 mm, available off the shelf from Edmund Optics. Other examples of such lenses can have focal lengths in ranges from 50 mm to 200 mm, 50 mm to 300 mm, 50 mm to 400 mm, and other ranges within the range of 50 mm to 500 mm. The depicted second projection system includes an arrangement of a projection device 45 (e.g., a DMD) in combination with a TIR prism 44 and turn mirror 43. The projection section of the depicted second projection system includes telecentric projection optics depicted as bi-telecentric projection optics (including an arrangement including three lenses 46, 49, 50, an optional iris 48, and an optional aspheric lens 47). Examples of lenses 46, 49, 50 include, but are not limited to, achromatic doublets with focal lengths in the range 50 mm to 500 mm, available off the shelf from Edmund Optics. Other examples of such lenses can have focal lengths in ranges from 50 mm to 200 mm, 50 mm to 300 mm, 50 mm to 400 mm, and other ranges within the range of 50 mm to 500 mm. An optional aspheric lens 47 is placed at or near the aperture stop of the projection optics and has spherical and aspherical curvature terms selected to further reduce spherical aberration and thus provide further improved lateral resolution at the image plane within container 56. Container 56 is positioned for receiving an optical projection projected from the second projection system. As discussed herein, the container is configured to include a volume of a photohardenable composition; at least a portion of the container is optically transparent so that the photohardenable composition is accessible by an optical projection of excitation light. The depicted system also includes a first projection system 33 including a light source 51 for generating collimated light at the first excitation wavelength, a Powell lens 52 for generating an angular distribution of light which has a widely spreading angular distribution in one direction and is collimated in the orthogonal direction, and cylinder lenses 53, 54, and 55 to convert the angular profile of the light exiting the Powell lens to a plane of light that is projected into container 56 such that it substantially overlaps the projection from the second projection system. Alternatively, a galvanometer, polygon scanner, MEMS scanner, diffractive optical elements, cylindrical lenses, or axicon lenses, with or without additional optical components, can be included in place of the Powell lens.

FIGS. 6A and 6B depict two views of the example of the first projection system depicted in FIG. 5 as a first projection system 33. FIG. 6A depicts an yz view and FIG. 6B xy view of the first projection system which can be used to generate a first optical projection comprising a plane of light or light sheet. The major face of the plane of light or light sheet is preferably orthogonal to the projection of the second optical projection in FIG. 5. The first projection system 33 depicted in FIGS. 6A and 6B includes a light source 51 which directs collimated light through an optical arrangement including a Powell lens 52, a first cylindrical lens 53, a second cylindrical lens 54, an optional third cylindrical lens 55 and into the container 56. An example of a collimated light source 51 is a free space laser. The Powell lens 52 accepts a collimated beam as input and generates a ray distribution including a fan with wide angular distribution in one direction and collimated light in the orthogonal direction. First cylinder lens 53 with an axis with nonzero curvature in the direction of the ray fan collimates the ray fan with wide angular distribution into a constant height plane of light with height dependent on the angular extent of the ray fan and the focal length of cylinder lens 53; second cylinder lens 54 with an axis with nonzero curvature orthogonal to the axis of cylinder lens 53 focuses the orthogonal collimated direction of the Powell lens output into container 56 for control of plane width and thus axial resolution, with plane width profile through the container 56 being dependent on the width of the collimated beam and the focal length of cylinder lens 54; and optional third cylinder lens 55 with an axis with nonzero curvature in the same direction as the axis of nonzero curvature of cylinder lens 53 compresses the height of the plane of light as it passes through the container, with compression amount dependent on the focal length of cylinder lens 55, thereby providing compensation for absorption in the resin to maintain constant irradiance along the first projection direction within the container. The use of cylinder lenses is preferred as this permits independent shaping of the light distribution in orthogonal directions. Examples of cylindrical lenses are off the shelf plano convex cylindrical lenses with focal lengths in the range 25 mm-250 mm, available from Thorlabs.

As mentioned above, a galvanometer, polygon scanner, MEMS scanner, diffractive optical elements, cylindrical lenses, or axicon lenses, with or without additional optical components, can be included in place of the Powell lens.

Light sources included in the system are preferably selected taking into consideration the photohardenable liquid being used and the hardening mechanism therefor. Such considerations include the wavelength(s) preferred for the particular photohardening mechanism and power levels preferred therefor. Selection of suitable light sources is within the skill of the person of ordinary skill in the relevant art.

While the figures depict examples of systems including a container configured to receive one or more optical projections generated by one or more projection systems, optionally the container can be included as a component of a system or separately provided for inclusion prior to use. Similarly, while the figures depict examples of systems including one or more projection systems including a light source, optionally any light source can be included as component of a projection system or can be separately supplied for inclusion in the system prior to use.

Alternative optical designs for providing telecentricity, in addition to the examples provided herein, can be included in the methods and systems in accordance with the present invention.

In accordance with another aspect of the present invention, there is provided a system for forming an object in a volume of a photohardenable composition, the system comprising: one or more projection systems configured for receiving excitation light and projecting one or more optical projections into the volume of the photohardenable composition, wherein at least one of the projection systems includes an optical arrangement for generating a light sheet, the optical arrangement including a collimated light source, one or more optical elements for receiving collimated light from the light source and generating a fan of light rays, a first cylinder lens for receiving the fan of light rays, and a second cylinder lens for receiving the light passing through the first cylinder lens, wherein the first cylinder lens includes an axis with nonzero curvature in the direction of the fan of light rays for collimating the fan of light rays into a substantially constant height plane of light and the second cylinder lens includes an axis with nonzero curvature orthogonal to the axis of the first cylinder lens to focus the orthogonal collimated direction of light output from the collimated light source the into container for control of plane width.

Optionally the optical arrangement further includes an optional third cylinder lens with an axis of nonzero curvature in the same direction as the axis of nonzero curvature of the first cylinder lens for compressing the height of the plane of light as it passes through the container. The compression amount is dependent on the focal length of the second cylinder lens and can provide compensation for absorption in the resin to maintain constant irradiance along the projection direction of the light sheet within the volume.

The inclusion of cylinder lenses with orthogonal axes in the path of the fan of light rays for generating a light sheet can provide facilitate independent control of the height of the light sheet and the width of the light sheet.

The inclusion of cylinder lenses with orthogonal axes in the path of the path of the fan of light rays for generating a light sheet can further provide compression to compensate for absorption in resin.

The system is preferably further configured to include a container for including the volume of the photohardenable composition. The container preferably includes at least one or more portions that are optically transparent so that the photohardenable composition is accessible by excitation light. A container can optionally be included as a component of the system or can be separately supplied. In either case, it can be desirable for the container to be removable from the system. It can further be desirable for the container to be reusable.

The system can further include one or more lighting sources which are arranged to provide excitation light to the one or more projection systems.

In accordance with another aspect of the present invention, there is provided a system for forming an object in a volume of a photohardenable composition, the system comprising two or more projection systems configured for receiving excitation light and projecting one or more optical projections to intersect at one or more selected location in the volume of the photohardenable composition to at least partially harden, polymerize, or crosslink the photohardenable composition to at least partially form one or more objects, wherein the one or more projection systems include a first projection system including an optical arrangement for generating a first optical projection comprising a light sheet, the optical arrangement including one or more optical elements for receiving excitation light and projecting the light sheet to the one or more selected locations in the volume, the optical elements including an element to generate the light sheet from excitation light and a first cylinder lens and a second cylinder lens configured for adjusting the dimensions of the light sheet, wherein the first cylinder lens includes an axis with nonzero curvature in the direction of the fan of light rays and the second cylinder lens includes an axis with nonzero curvature orthogonal to the axis of the first cylinder lens; and a second projection system including an illumination section, a projection device, and a projection section for projecting a second optical projection to a selected location in the volume, wherein at least one of the illumination section and projection system include telecentric optics.

The system is preferably further configured to include a container for including the volume of the photohardenable composition. The container preferably includes at least one or more portions that are optically transparent so that the photohardenable composition is accessible by excitation light. A container can optionally be a component of the system or can be separately supplied. In either case, it can be desirable for the container to be removable from the system. It can further be desirable for the container to be reusable.

The system can further include one or more lighting sources which are arranged to provide excitation light to the one or more projection systems.

Methods and systems described herein are useful for forming an object in a volume of a photohardenable composition.

A photohardenable composition can include a photopolymerizable or photohardenable component and a photoinitiator that initiates polymerization of the photopolymerizable component upon excitation by light.

Optionally, the photohardenable composition can further include other additives.

A photoinitiator can be readily selected by one of ordinary skill in the art, considering its suitability for the mechanism to be used to initiate polymerization as well as its suitability for and/or compatibility with the resin or photohardenable component to be polymerized. Other considerations in selecting a photoinitiator include the light absorption characteristics of the photoinitiator and the wavelength(s) of the excitation light to be used.

Examples of a hardenable component included in a photohardenable composition include any photohardenable resin or monomer suitable for the mechanism to be used to trigger the polymerization (radical mechanism, ionic mechanism, etc.). Examples of suitable hardenable components include, for example, without limitation, monomers, oligomers or polymers which can be polymerized by the radical route by addition or crosslinking mechanisms such as: acrylated monomers, such as acrylates, polyacrylates, methacrylates, or -acrylated oligomers such as unsaturated amides, or -methacrylated polymers, polymers which have a hydrocarbyl skeleton and pendant peptide groups with a functionality which can be polymerized by free radicals, or vinyl compounds such as styrenes, diallyl phthalate, divinyl succinate, divinyl adipate and divinyl phthalate, or -mixtures of several of the above monomers, oligomers or polymers, cationically polymerizable monomers and oligomers and cationically crosslinkable polymers, for example epoxy resins such as monomeric epoxies and polymeric epoxides having one or more epoxy groups, vinyl ethers, etc. and mixtures of several of these compounds.

Preferably the photohardenable composition comprises a photohardenable component and a photoswitchable photoinitiator, wherein the photoswitchable photoinitiator is activatable by exposure to light having a first wavelength and light having a second wavelength to induce hardening of the photohardenable composition (e.g., via a crosslinking or polymerization reaction in the photohardenable component) to partially or fully form an object in the volume of the photohardenable composition, wherein the first and second wavelengths are different. Optionally, the photohardenable composition can further include a coinitiator and/or a sensitizer. A sensitizer can create the excited state of the photoswitchable photoinitiator via absorbing light and transferring energy to the photoswitchable photoinitiator.

More preferably a photohardenable composition displays non-Newtonian rheological behavior which can facilitate forming an object in the volume without support structures and with minimal displaced of the object in the volume of the photohardenable composition during formation. Non-Newtonian behavior of the photohardenable composition can additionally simplify separation of the object from the volume of the photohardenable composition in which it is formed or printed.

Examples of such non-Newtonian rheological behavior include but are not limited to pseudoplastic fluid, yield pseudoplastic, or Bingham plastic.

Non-Newtonian rheological behavior can be imparted to the photohardenable composition by further including one or more reactive components (e.g. urethane acrylate oligomers, urethane methacrylate oligomers, acrylated or methacrylated polyurethanes, acrylated or methacrylated polyurethane-ureas, acrylated or methacrylated polyesters, acrylated or methacrylated polyamides, acrylate- or methacrylate-functional block copolymers, alkenyl- or alkynyl-functional urethane oligomers, alkenyl- or alkynyl-functional polyurethanes, alkenyl- or alkynyl-functional polyurethane-ureas, alkenyl- or alkynyl-functional polyesters, alkenyl- or alkynyl-functional polyamides, alkenyl- or alkynyl-functional block copolymers, thiol-functional urethane oligomers, thiol-functional polyurethanes, thiol-functional polyurethane-ureas, thiol-functional polyesters, thiol-functional polyamides, thiol-functional block copolymers) in the photohardenable component and/or by further adding one or more nonreactive additives (e.g., but not limited to, one or more thixotropes and/or rheology modifiers) to the photohardenable composition. Selection of the one or more of reactive components and the amounts thereof for addition to the photohardenable component to impart non-Newtonian rheological behavior thereto is within the skill of the skilled artisan in the relevant art without undue experimentation. Similarly, selection of nonreactive additives and the amount(s) thereof for addition to the photohardenable composition to impart non-Newtonian rheological behavior thereto is within the skill of the skilled artisan of the relevant art without undue experimentation.

For photohardenable composition in accordance with the present invention, preferred steady shear viscosities are less than 30,000 centipoise, more preferably less than 10,000 centipoise, and most preferably less than 1,000 centipoise. (Steady shear viscosity refers to the viscosity after the thixotrope network has broken up.)

Examples of photohardenable compositions for inclusion in the methods and systems of the present invention are provided in U.S. Patent Application No. 63/223,112 of Quadratic 3D, Inc. filed Jul. 19, 2021 for “Photohardenable Compositions, Methods For Forming An Object In A Volume Of A Photohardenable Composition, And Products Thereof, and U.S. Patent Application No. 63/226,605 of Quadratic 3D, Inc. filed Jul. 28, 2021 for “Photohardenable Compositions, Methods For Forming An Object In A Volume Of A Photohardenable Composition, And Products Thereof”, each of the foregoing being hereby incorporated herein by reference in its entirety.

Generally, photoswitchable photoinitiators useful in the above photohardenable compositions can absorb at about 300 to 450 nm. Depending upon the extinction coefficient for the particular photoswitchable photoinitiator, the conversion to the second form can be induced by exposure to any source which emits in this range, e.g., lasers, light emitting diodes, mercury lamps. Filters may be used to limit the output wavelengths. A non-limiting example of filtered light includes filtered emission from a mercury arc lamp, etc.

The second form of the photoswitchable photoinitiator will preferably absorb in a range of about 450 to 1000 nm and 450 to 850 most typically. This form can be activated by the second excitation light to produce free radicals directly or to produce excitons which undergo electron transfer, hydrogen abstraction(optionally via electron, proton, or energy transfer to a coinitiator(s) in aspects of the invention including one or more coinitiator) by exposure to any second wavelength within this range. For the second excitation, exposures may be accomplished using a laser source, an LED or LED array, the filtered emission from an arc lamp, or other suitable source with emission within the desired wavelength range. argon ion, He—Ne, laser diodes, krypton, frequency-multiplied Nd-YAG etc. Other light sources may be used, optionally with filters to limit output wavelengths, e.g., light emitting diodes, incandescent lamps, halogen lamps, mercury lamps, arc lamps, etc.

First excitation light and second excitation light included in the methods and systems of the present invention including two excitation wavelengths can include light having the same or different wavelength. However, when a photohardenable composition including a photoswitchable photoinitiator is included in a method or system of the present invention, the first and second excitation lights will include light having different wavelengths that are preferably selected based on the absorption characteristics of the particular photoswitchable photoinitiator.

For use in making objects (e.g., three-dimensional objects), it is desired that photohardenable compositions including photoswitchable photoinitiators do not harden (e.g., the photohardenable component does not undergo polymerization or cross-linking) upon exposure of the photohardenable composition to only the first wavelength or only the second wavelength. In other words, hardening of the photohardenable composition in the volume which is not simultaneously or nearly simultaneously (e.g., due to the closely timed sequential exposure) exposed to both radiations do not polymerize. In particular, in scanning a volume of the photohardenable media, as a result of beams passing through previously exposed areas or planes, there will be numerous points in the volume which are sequentially scanned in any order with the first wavelength radiation and the second wavelength radiation as the structure of the object is defined in the volume of the medium by the intersection of the beams. Some points may also experience multiple exposures to the first wavelength light and/or second wavelength light. It is desirable to select photoswitchable photoinitiators which rapidly reverse when they are not being exposed to first wavelength light.

Optionally, the first optical projection can comprise a plane of excitation light having a major face. Preferably, when the first optical projection comprises a plane of excitation light having a major face, the system is configured such that the major face of the first optical projection is orthogonal to the direction in which the second optical projection of excitation is projected into the volume.

The methods of the present invention include providing a volume of a photohardenable composition included within a container wherein at least a portion of the container is optically transparent so that the photohardenable composition is accessible by excitation light. Preferably, the entire container can be optically transparent.

Optically transparent portions of a container can be constructed from a material comprising, for example, but not limited to, glass, quartz, fluoropolymers (e.g., Teflon FEP, Teflon AF, Teflon PFA), cyclic olefin copolymers, polymethyl methacrylate (PMMA), polynorbornene, sapphire, or transparent ceramic.

A container can further include filters on its outer surfaces or around the outer surfaces to block certain wavelengths.

Examples of container shapes include, but are not limited to, a cylindrical container having a circular or oval cross-section, a container having straight sides with a polygonal cross-section or a rectangular or square cross-section.

Preferably the optically transparent portion(s) of the container is (are) also optically flat.

As discussed above, in the systems and methods in accordance with the present invention, the selection of wavelength(s) of the excitation light for the excitation light projections is preferably made taking into account the photohardenable composition and hardening mechanism being used.

For example, for photohardenable compositions that are hardenable via a hardening mechanism that involves a single wavelength of excitation light, the wavelength of the excitation light projection(s) can be the same. Optionally in such case, an excitation light projection including a different wavelength light can also be included, for example for inhibiting undesired hardening of the photohardenable composition.

In cases where a photohardenable composition is hardenable via a hardening mechanism that involves more than wavelengths of excitation light, the wavelengths of the excitation light projections will be selected for projecting excitation light with appropriate wavelengths for the hardening mechanism. Optionally an additional wavelength light can also be used to inhibit undesired hardening of the photohardenable composition.

Systems and methods in accordance with the present invention can further include one or more control system for controlling at least one of: the selective projection of the at least two excitation light projections into the volume of photohardenable composition at one or more selected locations.

A discussed above, the methods and systems described herein may be used in combination with a computer and software. Software can be used to coordinate generation of optical projections (e.g., point illuminations, line illuminations, a two-dimensional pattern, or a light sheet) from their respective optical projection system at each position along the projection direction of each so that the part is developed plane by plane. The planar face of an optical projection can be orthogonal to its projection direction into photohardenable composition. When two optical projections are projected into the volume of photohardenable composition, the projection directions of the two projections are preferably orthogonal to each other. Selection of computer controls and software is within the skill of the person of ordinary skill in the relevant art. Other components can also optionally be included or used with the system.

Systems and methods in accordance with the present invention advantageously further do not require adhering the object being printed to a fixed substrate (e.g., build plate) at the beginning of the printing process avoiding a post-processing step of separating the printed object from the fixed substrate.

In systems and methods in accordance with aspects of the invention including at least two excitation light projections, optionally one or more of the two excitation light projections can comprise a light sheet (also referred to herein as a plane of light including a major face), which may be constructed by means known in the art including, for example, but not limited to: cylindrical lens, Powell lens, galvonometer, polygon scanning mirror, MEMS scanner, axicon lens.

Optical resolution refers to the ability of an optical imaging system to resolve detail in the object being imaged. There are many known metrics that can be used to quantify optical resolution, and the choice of most appropriate metric depends on the type of optical system and its performance requirements.

Lateral resolution refers to the optical resolution in the plane normal to the optical axis. For example, a metric for lateral resolution can be the diameter of the smallest illuminated spot produced by an imaging system in response to a point source of illumination, where diameter is defined as the width of the light distribution where intensity falls below a chosen percentage of the peak value, such as 50%.

Axial resolution refers to the optical resolution along the direction of the optical axis. For example, a metric for axial resolution can be to determine the specific point along the optical axis where the smallest illuminated spot lies, then to take the distance between two specific points closer and farther along the optical axis, where the diameter of the illuminated spot is some chosen factor larger, such as 5× larger, than the diameter of the smallest illuminated spot.

Optionally, one or both of the optical projection systems and/or the container is supported on a stage that is at least translationally movable in one or more of the x, y, and z directions.

An optical projection of excitation light can comprise an image, a two-dimensional image, a patterned image, a patterned two-dimensional image, a line of light, a plane of light (or a light sheet), or a single point of light. A two-dimensional image can comprise a cross-sectional plane of the three-dimensional image being printed. The methods described herein can further comprise carrying out step (c) to achieve hardening of the photohardenable composition at one or more additional regions within the volume of the photohardenable composition until the desired degree of formation of the object is formed. For example, partial formation of an object may be desired or full formation of an object may be desired. In either case, further processing of the object can optionally be carried out.

The methods described herein can further comprise removal the formed three-dimensional object from the container. Following removal from the container, the completed object can be further processed. Examples of further processing include, without limitation, a post-curing step to complete any partial polymerization, washing the formed three-dimensional object, packaging, etc.

A system in accordance with the present invention can optionally further include one or more sections or units for completing one or more processing steps on the objects produced by the system. Examples of such additional processing sections include, without limitation, a post-curing unit to further cure any partial polymerization, a washing unit for washing the three-dimensional objects formed in the volume, a packaging unit, an inspection unit.

Examples of projection devices for use in the methods and systems described herein may include, but are not limited to, a laser projection system, a liquid crystal display (also referred to herein as “LCD”), a spatial light modulator (also referred to herein as “SLM”) (for example, but not limited to, a digital micromirror device (also referred to herein as “DMD”)), a micro-LED array, a vertical cavity laser array (also referred to herein as “VCL”), a Vertical Cavity Surface Emitting Laser array (also referred to herein as “VCSEL”), a liquid crystal on silicon (also referred to herein as “LCoS”) projector, and a scanning laser system. (Light emitting diode is also referred to herein as “LED”.)

A projection system can optionally further include one or more optical components (e.g., projection optics, illumination optics, lenses, lens systems, mirrors, prisms, etc.) A projection system can optionally further include one or more light sources as part of the projection system or separately provided for inclusion in the projection system prior to use for illuminating the projection device.

Examples of light sources of the excitation light that may be suitable for use in various aspects of the present invention including light sources include, by way of example and non-limitation, lasers, laser diodes, light emitting diodes, light-emitting diodes (LEDs), micro-LED arrays, vertical cavity lasers (VCLs), and filtered lamps. Such light sources are commercially available and selection of a suitable light source can be readily made by one of ordinary skill in the relevant art. LEDs of the type such as Phlatlight LEDs available from Luminus for use with DMDs can be preferred.

Optionally, the excitation light can be temporally and/or spatially modulated. Optionally, the intensity of the excitation light can be modulated. Optionally, source drive modulation can be used to adjust the absolute power of the light beam.

Spatially modulated excitation light can be created by known spatial modulation techniques, including, for example, a liquid crystal display (LCD), a digital micromirror device (DMD), or a microLED array. Other known spatial modulation techniques can be readily identified by those of ordinary skill in the relevant art.

A projection system can be configured to apply continuous excitation light. A projection system can be configured to apply intermittent excitation light. Intermittent excitation can include random on and off application of light or periodic application of light. Examples of periodic application of light includes pulsing. A projection system can be configured to apply a combination of both continuous excitation light and intermittent light, including, for example, an irradiation step that includes the application of intermittent excitation light that is preceded or followed by irradiation with continuous light. Intermittent light may facilitate use of a higher instantaneous light intensity to increase printing speed.

As discussed above, in addition to a projection device, a projection system can further include additional components including, but not limited to, projection optics, and one or more translational stages for moving the system or components thereof.

The methods and systems disclosed herein can optionally further include the use commercially available projection and filtering techniques.

Projection devices or projection systems included in the systems and methods described herein may be used in combination with a computer and software. Software can be used to coordinate generation of optical projections (e.g., point illuminations, line illuminations, a two-dimensional pattern, or a light sheet) from their respective optical projection system at each position along the projection direction of each so that the part is developed plane by plane. The planar face of an optical projection can be orthogonal to its projection direction into photohardenable composition. When two optical projections are projected into the volume, the projection directions of the two projections are preferably orthogonal to each other. Selection of computer controls and software is within the skill of the person of ordinary skill in the relevant art. Other components can also optionally be included or used with the system.

Other information that may be useful in connection with the present invention include U.S. Patent Application No. 63/223,112 of Quadratic 3D, Inc. filed Jul. 19, 2021 for “Photohardenable Compositions, Methods For Forming An Object In A Volume Of A Photohardenable Composition, And Products Thereof, U.S. Patent Application No. 63/226,605 of Quadratic 3D, Inc. filed Jul. 28, 2021 for “Photohardenable Compositions, Methods For Forming An Object In A Volume Of A Photohardenable Composition, And Products Thereof”, U.S. Pat. No. 10,843,410 of Lippert, et al. for “System And Method For A Three-Dimensional Optical Switch Display (OSD) Device”, and U.S. Pat. No. 5,230,986 of Neckers, each of the foregoing being hereby incorporated herein by reference in its entirety.

The systems and methods of the present invention may be useful with other 3D printing techniques that include initiation of a photochemical reaction in a photoreactive system via the absorption of light energy supplied by one or more excitation light projections to form an object. Examples include tomographic printing, two-photon printing, upconversion printing, and dual-wavelength printing.

Before forming an object or “printing”, a digital file of the object to be printed is obtained. If the digital file is not of a format that can be used to print the object, the digital file is then converted to a format that can be used to print the object. An example of a typical format that can be used for printing is an STL file. Typically, the STL file is then sliced into two-dimensional layers with use of three-dimensional slicer software and converted into G-Code or a set of machine commands, which facilitates building the object. See B. Redwood, et al., “The 3D Printing Handbook—Technologies, designs applications”, 3D HUBS B.V. 2018.

When used as a characteristic of a portion of a container or build chamber, “optically transparent” refers to having high optical transmission to the wavelength of light being used, and “optically flat” refers to being non-distorting (e.g., optical wavefronts entering the portion of the container or build chamber remain largely unaffected).

As used herein, the singular forms “a”, “an” and “the” include plural unless the context clearly dictates otherwise. Thus, for example, reference to an emissive material includes reference to one or more of such materials.

Applicant specifically incorporates the entire contents of all cited references in this disclosure. Further, when an amount, concentration, or other value or parameter is given as either a range, preferred range, or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

Other embodiments of the present invention will be apparent to those skilled in the art from consideration of the present specification and practice of the present invention disclosed herein. It is intended that the present specification and examples be considered as exemplary only with a true scope and spirit of the invention being indicated by the following claims and equivalents thereof.

1-55. (canceled)

56. A system for forming an object in a volume of a photohardenable composition, the system comprising: one or more projection systems configured for receiving excitation light and projecting two or more optical projections into the volume of the photohardenable composition, the two or more optical projections including a first optical projection including a first excitation light having a first wavelength and a second optical projection including a second excitation light having a second wavelength, wherein at least one of the projection systems includes a projection device and one or more telecentric optics arrangements positioned in: (a) the optical illumination path of the second excitation light for illuminating the projection device for projecting the second optical projection and/or (b) the optical projection path between the projection device for projecting the second optical projection and the volume of the photohardenable composition.

57. (canceled)

58. (canceled)

59. The system of claim 56 wherein a first telecentric optics arrangement is positioned in the optical illumination path of the second excitation light for illuminating the projection device for projecting the second optical projection.

60. (canceled)

61. The system of claim 56 wherein a second telecentric optics arrangement is positioned in the optical projection path between the projection device for projecting the second optical projection and the volume of the photohardenable composition.

62. (canceled)

63. The system of claim 56 wherein the system includes a first telecentric optics arrangement positioned in the optical illumination path of the second excitation light for illuminating a projection device for projecting the second optical projection and a second telecentric optics arrangement positioned in the optical projection path between the projection device for projecting the second optical projection and the volume of the photohardenable composition.

64. (canceled)

65. The system of claim 56 wherein the inclusion of a first telecentric optics arrangement in the optical illumination path of the second excitation light for illuminating the projection device and the inclusion of a second telecentric optics arrangement for projecting the second optical projection facilitate interchangeability of projection lenses included in a projection lens system in the optical path between the projection device for projecting the second optical projection and the volume of the photohardenable composition with telecentric lens of various fixed or variable (e.g., zoom) magnifications for adjusting the size of the printing field in the volume and/or resolution of the object formed in the volume.

66. (canceled)

67. The system of claim 56 wherein the inclusion of a first telecentric optics arrangement in the optical illumination path of the second excitation light for illuminating a projection device for projecting the second optical projection and a second telecentric optics arrangement in the optical projection path between the projection device for projecting the second optical projection and the volume of the photohardenable composition facilitate generation by the second projection system of a projection of numerical aperture of light rays of 0.1 or higher when using a DMD as the projection device.

68. (canceled)

69. (canceled)

70. The system of claim 56 wherein the positioning of the telecentric optics arrangement in the optical projection path between the projection device for projecting the second optical projection and the volume of the photohardenable composition facilitates producing an image with substantially constant magnification over a range of axial depths within the photohardenable composition.

71. The system of claim 56 wherein the photohardenable composition comprises a photohardenable component and a photoswitchable photoinitiator, wherein the photoswitchable photoinitiator is activatable by exposure to first excitation light including light having the first wavelength and second excitation light including light having the second wavelength to induce hardening in the photohardenable component (e.g., via a crosslinking or polymerization reaction) to partially or fully form an object in the volume of the photohardenable composition.

72. The system of claim 56 wherein the first excitation and second excitation light have different wavelengths.

73. The system of claim 56 wherein the first optical projection comprises a plane of excitation light or a light sheet.

74. (canceled)

75. The system of claim 56 wherein the system is configured such that a major face of the plane of light or light sheet is orthogonal to the direction in which the second optical projection of excitation is projected into the volume.

76-83. (canceled)

84. The system of claim 56 wherein the one or more of the telecentric optics arrangement positioned in: (a) the optical illumination path of the second excitation light for illuminating a projection device for projecting the second optical projection and/or (b) the optical projection path between the projection device for projecting the second optical projection and the volume of the photohardenable composition include object-side telecentricity.

85. The system of claim 56 wherein the one or more of the telecentric optics arrangement positioned in: (a) the optical illumination path of the second excitation light for illuminating a projection device for projecting the second optical projection and/or (b) the optical projection path between the projection device for projecting the second optical projection and the volume of the photohardenable composition include image-side telecentricity.

86. The system of claim 56 wherein the one or more of the telecentric optics arrangement positioned in: (a) the optical illumination path of the second excitation light for illuminating a projection device for projecting the second optical projection and/or (b) the optical projection path between the projection device for projecting the second optical projection and the volume of the photohardenable composition include bi-telecentricity (object-side telecentricity and image-side telecentricity).

87. A system for forming an object in a volume of a photohardenable composition, the system comprising: one or more projection systems configured for receiving excitation light and projecting one or more optical projections into the volume of the photohardenable composition, wherein at least one of the projection systems includes an optical arrangement for generating a light sheet, the optical arrangement including a collimated light source, one or more optical elements for receiving collimated light from the light source and generating a fan of light rays, a first cylinder lens for receiving the fan of light rays, and a second cylinder lens for receiving the light passing through the first cylinder lens, wherein the first cylinder lens includes an axis of nonzero curvature in the direction of the fan of light rays for collimating the fan of light rays into a substantially constant height plane of light and the second cylinder lens includes an axis of nonzero curvature orthogonal to the axis of the first cylinder lens to focus the orthogonal collimated direction of light output from the collimated light source into the volume of the photohardenable composition for control of plane width.

88. The method of claim 87 further including the container adapted to include the volume of the photohardenable composition, wherein at least a portion of the container is optically transparent so that the photohardenable composition is accessible by excitation light.

89. The system of claim 87 wherein the optical arrangement for generating the light sheet further includes a third cylinder lens between the second cylinder lens and the volume of the photohardenable composition.

90. A system for forming an object in a volume of a photohardenable composition, the system comprising: two or more projection systems configured for receiving excitation light and projecting one or more optical projections to intersect at one or more selected location in the volume of the photohardenable composition to at least partially harden, polymerize, or crosslink the photohardenable composition to at least partially form one or more objects, wherein the one or more projection systems include a first projection system including an optical arrangement for generating a first optical projection comprising a light sheet, the optical arrangement including one or more optical elements for receiving excitation light and projecting the light sheet to the one or more selected locations in the volume, the optical elements including a an element to generate the light sheet from excitation light and a first cylinder lens and a second cylinder lens configured for adjusting the dimensions of the light sheet, wherein the first cylinder lens includes an axis of nonzero curvature in the direction of the height of the light sheet and the second cylinder lens includes an axis of nonzero curvature orthogonal to the axis of nonzero curvature of the first cylinder lens; and a second projection system including an illumination section, a projection device, and a projection section for projecting a second optical projection to a selected location in the volume, wherein at least one of the illumination section and projection system include telecentric optics.

91. The of claim 90 further including a container adapted to include the volume of the photohardenable composition, wherein at least a portion of the container is optically transparent so that the photohardenable composition is accessible by excitation light.

92. (canceled)

93. The system of claim 90 wherein the second projection system includes telecentric illumination optics and telecentric projection optics.

94. The system of claim 93 wherein each of the telecentric illumination optics and telecentric projection optics include bi-telecentricity.
